(19) United States
(12) Patent Application Publication
(10) Pub. No.: US 2009/0232032 A1
(43) Pub. Date: Sep. 17, 2009

(54) Methods and Apparatus for the Manipulation of Conferenced Data

(75) Inventor: Timothy D. Kelley, Erie, CO (US)

Correspondence Address: SANTANGELO LAW OFFICES, P.C., 125 SOUTH HOWES, THIRD FLOOR, FORT COLLINS, CO, 80521, US

(73) Assignee: VERBAL WORLD, INC., Boulder, CO (US)

(21) Appl. No.: 12/436,745

(22) Filed: May 6, 2009

Related U.S. Application Data
(63) Continuation-in-part of application No. PCT/US09/33580, filed on Feb. 9, 2009.
Application No. PCT/US09/33580 is a continuation-in-part of application No. PCT/US07/01242, filed on Jan. 17, 2007.
(60) Provisional application No. 61/050,953, filed on May 6, 2008.
(60) Provisional application No. 61/050,953, filed on May 6, 2008.
(60) Provisional application No. 61/050,960, filed on May 6, 2008.
(60) Provisional application No. 61/027,303, filed on Feb. 8, 2008.

(51) Int. Cl. H04L 12/16

(52) U.S. Cl. 370/261; 370/260

(57) ABSTRACT

Methods and apparatus may permit the manipulation of conferenced data. Primary sequenced audio-optical data structures may be populated with conferenced data, and secondary sequenced audio-optical data structures may be populated with derivative conferenced data. Electronic identity characteristics may be utilized to selectively deny access of conference participants to an exchange of conferenced electronic communications, verify the identity of prospective conference participants to an exchange of conferenced electronic communications, and verify the identity of known and unknown individuals in conjunction with electronic identity signatures. Conferenced data tags may be associated to conferenced data elements to create derivative conferenced data. Derivative conferenced data may be utilized in conjunction with primary conferenced data structures and secondary conferenced data structures to create augmented functionalities for conferenced data elements.

This application is a continuation-in-part of International Application No. PCT/US2007/001242, filed Jan. 17, 2007; this application claims benefit of and priority to U.S. Provisional Application No. 61/050,953, filed May 6, 2008; this application is a continuation-in-part of International Application No. PCT/US2009/033580, filed Feb. 9, 2009, which claims benefit of and priority to U.S. Provisional Application No. 61/050,953, filed May 6, 2008, and U.S. Provisional Application No. 61/050,960, filed May 6, 2008, and U.S. Provisional Application No. 61/027,303, filed Feb. 8, 2008; each hereby incorporated herein by reference in their entirety.

### BACKGROUND OF THE INVENTION

In modern economies, information is a commodity. Decision making on both macroeconomic and microeconomic levels is driven by the assessment and evaluation of information related to the various factors that may be relevant to a given decision. Be it a consumer evaluating product offerings for a home electronics purchase or a corporation assessing market forces for a major business investment, the process of information gathering has become integral to the conduct of modern economic transactions.

A substantial technological infrastructure has been developed dedicated to increasing the efficiency with which large amounts of information can be utilized. In the computer age, it may be that early iterations of this technological infrastructure have been devoted to processing information embodied in the written word. One widespread, perhaps obvious example of this may be the widespread use of word processing applications, such as Wordperfect or Microsoft Word. Such word processing applications arguably have revolutionized the efficiency with which written information can be generated and utilized when compared to older technologies such as typewriters, mimeographs, or even longhand writing. However, it may be appreciated that useful information may be embodied in a variety of forms not limited to merely the written word.

One such kind of useful information may be audio-optical information. The term audio-optical may be understood to include information embodied in either or both of information that is audibly perceptible and/or visually perceptible to an end user of such information. It may be easy to understand the concept of audio-optical information by contrasting to its related cousin, audiovisual information, which generally may be understood to embody information that is both audibly and visually perceptible to an end user. Regardless, it may be readily appreciated that many kinds of useful information may be embodied as audio-optical, for example such as speech communication, video programming, music, and the like, but certainly not limited to the foregoing.

Moreover, a variety of approaches may have been taken in an attempt to increase the efficiency of information gathering and utilization. One approach may be to organize information into primary information content and secondary information content. Primary information content may include information relevant for a desired purpose, for example such as decision-making. Secondary information content may include information the value for which derives substantially from its relation to primary information content, for example perhaps metadata. Organizing information into primary information content and secondary information content may increase the efficiency with which information may be gathered and utilized to the degree that primary information may be used with more versatility for its intended purpose when associated to secondary information content. However, the full potential of organizing information into primary information content and secondary information content is not yet realized, particularly with respect to audio-optical information.

Accordingly, there seems to exist an unfulfilled, long-felt need to process audio-optical information with increased efficiency, perhaps such as may be comparable to the efficiency with which word processing applications process the written word. While conventional technology may exist to process audio-optical information, such conventional technology may suffer from a variety of drawbacks tending to reduce the efficiency of such processing.

For example, audio-optical information may be digitally stored by conventional technology in standardized block sizes of perhaps 512 bytes. Such standardized block sizes, in turn, may define the points at which the digitally stored audio-optical data may be accessed. For example, it may be that such digitally stored audio-optical data may be directly accessed only at points corresponding to the boundaries of any individual block in which the audio-optical information is stored, e.g., at the beginning or ending of a block. As a result, it may be that portions of the digitally stored audio-optical information that happen to fall between the boundaries of a block may not be capable of optimal access, and instead perhaps must be accessed through indirect means, such as on a runtime basis.

With regard to audio-optical information, conventional technology also routinely may store metadata information as a separately indexed file. Such metadata information may include information for locating certain kinds of content within associated audio-optical information. However, the fact of separately indexing the metadata from the audio-optical information may result in the necessity to keep track of two information elements in order to retain the functionality of the metadata to the audio-optical information. Should the metadata ever become dissociated from the audio-optical information, for example perhaps through error in devices such as computer memory, then it may be possible to lose the benefit of the metadata information.

Conventional technology also may be limited by inefficient methods of accessing specific portions of audio-optical content within larger audio-optical information structures. For example, conventional technology may rely on using runtime processes to access such specific portions of audio-optical content. In some applications, such runtime processes may permit navigation through audio-optical content only with reference to a time index of where the content occurs, without regard to the substance of the content itself. Similarly other applications may require navigation of audio-optical content only on a text-indexed basis. Such text indexing may require the separate step of converting the audio-optical content from its native audio-optical format to text, and even then the benefit to the user of working with audio-optical information largely may be lost, or accuracy compromised, because the user may perceive the converted audio-optical information only in text form. In any case, these conventional methods of accessing specific portions of audio-optical content may be relatively slow, perhaps unacceptably slow for large volumes of audio-optical information, and in some cases perhaps may be limited to the playback rate of the audio-optical content itself.

To the degree conventional technology may allow specific portions of audio-optical content to be retrieved, the conventional technology may be limited by retrieving such specific portions out of optimal context with respect to the surrounding audio-optical content in which the portion is situated. For example, conventional technology may not confer the ability to selectively define the nature and extent of contextual information to be retrieved, for example, retrieving the sentence in which a word appears, retrieving the paragraph in which a sentence appears, retrieving the scene in which a frame of video appears, and so forth. Accordingly, conventional technology may return to a user searching for particular information within audio-optical content only that specific information searched for, with limited or no context in which the information appears, and the user may lose the benefit of such context or may have to expend additional time retrieving such context.

In many conventional applications, speech information may be sought to be manipulated in one manner or another. For example, some applications may be designed to allow a user to search speech information to find the occurrence of a specific word or phrase. In this regard, conventional technology may be limited in its ability to achieve such kinds of manipulation of speech information to the degree that the speech information first may have to be converted to text. It may be that conventional technologies for working with speech information may only be able to do so on a text basis, and perhaps may not be able to optimally manipulate speech in its native audio-optical format, for example such as by using phonemes to which the speech information corresponds.

Conventional technology also may be limited to structuring audio-optical data in standardized block sizes, perhaps block sizes of 512 bytes in size. This may result in an inefficient structuring of audio-optical information if the data content of such audio-optical information is not well matched to the standardized block size. Further, it often may be the case that audio-optical information stored in standardized block sizes may result in leading or trailing data gaps, where portions of a standardized block may contain no data because the audio-optical information was smaller than an individual block or spilled over into the next connected block.

In some conventional applications, metadata may be associated to audio-optical information perhaps by appending a metadata structure directly to underlying audio-optical data. However, to the degree it may become desirable to change such metadata, the conventional technology may be limited in its ability to accomplish such changes. For example, it may be the case that some conventional technology may require the entire metadata structure to be rewritten if a change is desired, even if the change is only for one portion of the metadata. This may make it difficult to modify the metadata on an ongoing basis over time, for example perhaps in response to changes or analysis carried out with respect to the underlying audio-optical data. Moreover, it may be common for metadata structures to exist in a standardized manner wherein only standardized types of metadata in standardized formats are used for relevant metadata structures. In this manner, accomplishing changes to metadata of this type may entail inefficiencies that may complicate their use with audio-optical content.

In addition, each of the foregoing problems may be exacerbated with respect to conferenced data, which may present additional data processing difficulties due to the distributed nature of conferenced communications.

The foregoing problems regarding conventional technologies may represent a long-felt need for an effective solution to the same. While implementing elements may have been available, actual attempts to meet this need to the degree now accomplished may have been lacking to some degree. This may have been due to a failure of those having ordinary skill in the art to fully appreciate or understand the nature of the problems and challenges involved. As a result of this lack of understanding, attempts to meet these long-felt needs may have failed to effectively solve one or more of the problems or challenges here identified. These attempts may even have led away from the technical directions taken by the present inventive technology and may even result in the achievements of the present inventive technology being considered to some degree an unexpected result of the approach taken by some in the field.

### SUMMARY OF THE INVENTION

The inventive technology relates to methods and apparatus for the manipulation of conferenced data and in embodiments may include the following features: techniques for using secondary data content to access primary audio-optical data content interpolated within memory unit formats; techniques for using integrated secondary data content to interstitially access primary audio-optical data content populated within a primary audio-optical data structure; techniques for locating primary audio-optical data content on a byte order basis; techniques for contextually retrieving audio-optical data content; techniques for manipulating speech data on a phoneme basis; techniques for structuring primary audio-optical data in a variable memory unit format; techniques for selectively altering integrated secondary sequenced audio-optical data structures; techniques for selectively denying access to conferenced electronic communications; techniques for completing an exchange of conferenced electronic communications; techniques for creating derivative conferenced data; and techniques for electronic identity verification. Accordingly, the objects of the methods and apparatus for manipulating primary audio-optical data content and associated secondary data content described herein address each of the foregoing in a practical manner. Naturally, further objects of the invention will become apparent from the description and drawings below.

### BRIEF DESCRIPTION OF THE DRAWINGS

FIG. 1 is a representation of a sequenced audio-optical interpolated data access apparatus in one embodiment.

FIG. 2 is a representation of a sequenced audio-optical interstitial data access apparatus in one embodiment.

FIG. 3 is a representation of a sequenced audio-optical data location apparatus in one embodiment.

FIG. 4 is a representation of a contextual sequenced audio-optical data retrieval apparatus in one embodiment.

FIG. 5 is a representation of a phoneme data storage apparatus in one embodiment.

FIG. 6 is a representation of an audio-optical data structuring apparatus in one embodiment.

FIG. 7 is a representation of a sequenced audio-optical data alteration apparatus in one embodiment.

FIG. 8 is a representation of a multiple line cooperative secondary audio-optical data structure in one embodiment.

FIG. 9 is a representation of a conferenced electronic communications access apparatus in one embodiment.

FIG. 10 is a representation of a conferenced electronic communications exchange completion apparatus in one embodiment.

FIG. 11 is a representation of a derivative conferenced data creation apparatus in one embodiment.

FIG. 12 is a representation of an electronic identity verification apparatus in one embodiment.

### DETAILED DESCRIPTION OF THE PREFERRED EMBODIMENTS

The present inventive technology includes a variety of aspects, which may be combined in different ways. The following descriptions are provided to list elements and describe some of the embodiments of the present inventive technology. These elements are listed with initial embodiments, however it should be understood that they may be combined in any manner and in any number to create additional embodiments. The variously described examples and preferred embodiments should not be construed to limit the present inventive technology to only the explicitly described systems, techniques, and applications. Further, this description should be understood to support and encompass descriptions and claims of all the various embodiments, systems, techniques, methods, devices, and applications with any number of the disclosed elements, with each element alone, and also with any and all various permutations and combinations of all elements in this or any subsequent application.

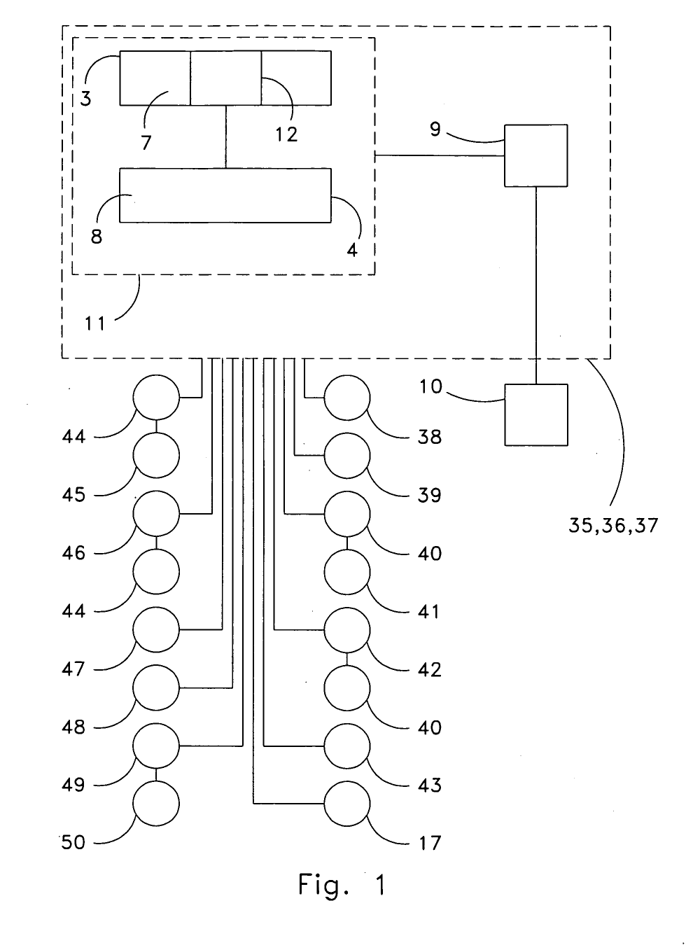

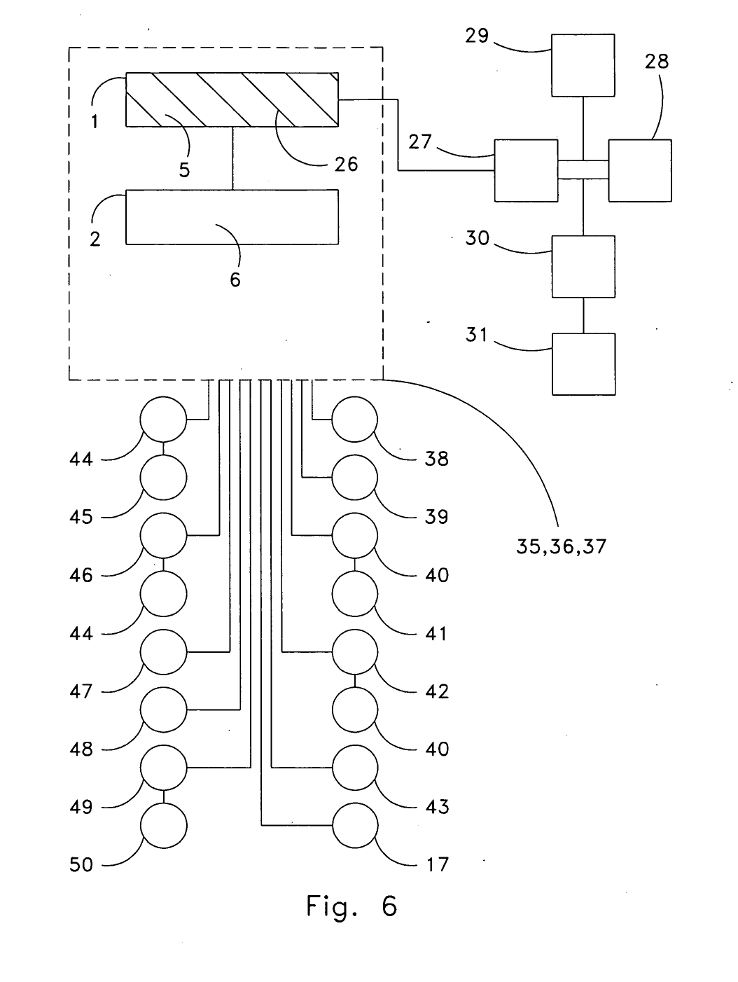

The inventive technology in various embodiments may involve utilizing data. As may be seen in FIG. 1, for example, embodiments may include establishing a primary sequenced audio-optical data structure (3) and a secondary sequenced audio-optical data structure (4). Perhaps more generally, embodiments may involve establishing simply a primary audio-optical data structure (1) and a secondary audio-optical data structure (2), as may be seen in FIG. 6.

Similarly, as may be seen in FIG. 1, embodiments may include populating such data structures with primary sequenced audio-optical data content (7) and secondary sequenced audio-optical data content (8). Perhaps more generally, such data structures may be populated simply with primary audio-optical data content (5) and secondary audio-optical data content (6), as may be seen in FIG. 6.

The term data structure, including perhaps the data structures seen in FIGS. 1-7, may be understood to include any appropriate format in which data content may be maintained in a coherent structure. Accordingly, data content may be populated within a data structure in various embodiments. The term populating may be understood to include simply fixing data content within a data structure in a stable form. Moreover, data content may be comprised of one or more data elements. The term data element may be understood to include a constituent part of data content, including perhaps merely a portion of the data content or perhaps even the entire data content if appropriate

Data structures may be populated with any data content for which the data structure may be suited, including perhaps the data content shown for some embodiments in FIGS. 1-7. In various embodiments, data structures may be populated with audio-optical data content, which may be understood to include data content that embodies information that is either or both of audibly perceptible and/or visually perceptible to an end user of such information. In certain embodiments, audio-optical data content may be sequenced audio-optical data content. Sequenced audio-optical data content may be understood to be data content that embodies audio-optical information that must be perceived by a user in sequential format for the user to gain understanding of the data content's information meaning. For example, sequenced audio-optical data content may include audio data (of any number of types including speech data, music data, non-speech audio data, and the like) and video data. By way of contrast, picture data may not be sequenced audio-optical data content, because a picture may not regularly be designed to be sequentially presented to a viewer to gain understanding of the picture's information.

Data content in various embodiments may include primary data content and secondary data content, perhaps as may be seen in FIGS. 1-7. Primary data content may include data content that embodies primary information. Secondary data content may include data content that embodies secondary information, and may be content as contained in an ancillary or perhaps even non-original or later added location. When primary data content is populated within a data structure, the data structure may be termed a primary data structure. Examples of primary data structures may include .wav files, .mpg files, .avi files, .wmv files, .ra files, .mp3 files, and .flac files. Similarly, when secondary data content is populated within a data structure, the data structure may be termed a secondary data structure. Examples of secondary data structures may include .id3 files, .xml files, and .exif files. Moreover, both primary data structures and secondary data structures may exist in a compressed or uncompressed state.

In this manner, it may be appreciated that data structures may be named to reflect the type of data content with which they are populated, perhaps such as may be seen in FIGS. 1-7. In particular, embodiments may include naming primary data structures to reflect the type of primary data content they are populated with, and naming secondary data structures to reflect the type of primary data content to which the secondary data content is associated. Similarly, it may be appreciated that data content may be named to reflect the type of information embodied by the data content, again perhaps as may be seen in FIGS. 1-7.

The data discussed herein naturally may be of any suitable type for a given data processing application that may utilize the inventive technology. One example may include voice mail messaging technology, wherein primary data content may be a voice mail message and secondary data content may be metadata related to the voice mail. Another example may include data mining of video footage, as perhaps wherein primary data content may include a large stock of video footage, and secondary data content may involve metadata related to a scene or event within the video footage. Naturally, however, these examples are merely illustrative of the data that may be utilized, and the inventive technology is not limited to merely these examples.

Referring now to FIGS. 1-7, it can be appreciated that in various embodiments, a secondary sequenced audio-optical data structure (4) may be an integrated secondary sequenced audio-optical data structure (4). The term integrated may include simply secondary sequenced audio-optical data structures (4) that are joined with a primary sequenced audio-optical data structure (3) such that both the primary sequenced audio-optical data structure (3) and the secondary sequenced audio-optical data structure (4) are usually stored as a single unit. Stated differently, integrated secondary sequenced audio-optical data structures (4) may not be stored as separately indexed units or files from their associated primary sequenced audio-optical data structures (3). In some embodiments, an example of an integrated secondary sequenced audio-optical data structure (4) may be an attached header file that is directly attached to a primary data structure. In a voice mail context, for example, metadata concerning a voice mail message may be contained in a header file directly attached to the voice mail message. Similarly, in a data mining context, a data mined scene or event from video footage may be contained as metadata in a header file attached directly to the video footage.

It may be appreciated that any appropriate information may be included within a secondary sequenced audio-optical data structure (4) to create a desired relationship to an associated primary audio-optical data structure (1). This perhaps may be represented by the lines shown for some embodiments between the two rectangles in FIGS. 1-7. For example, a secondary sequenced audio-optical data structure (4) in various embodiments may include byte location information of data content in a primary audio-optical data structure (1), signature information related to data content in a primary audio-optical data structure (1), or even phoneme information related to data content in a primary audio-optical data structure (1). The term byte location may be understood to include simply a location of a specific byte or bytes within an arrangement of bytes. In some embodiments, byte location information in a secondary sequenced audio-optical data structure (4) may be a byte table. Such a byte table of course may include any number of byte locations arranged to coordinate to information located in a primary sequenced audio-optical data structure (3). For example, in some embodiments, a byte table may be populated with byte locations for the boundaries of memory units in a memory unit format (12) for primary data content.

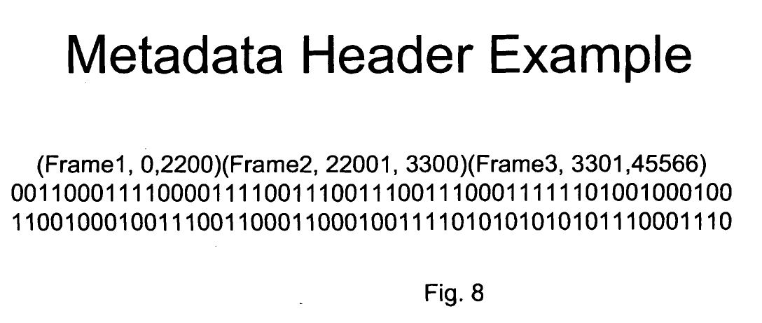

Moreover, the secondary audio-optical data structure (2), as may be shown for some embodiments by the rectangle in FIGS. 1-7, may be formatted to any form suitable to most effectively utilize data content populated therein. For example, embodiments may involve establishing a multiple line cooperative secondary audio-optical data structure (2), perhaps as shown in one embodiment by FIG. 8. By the term multiple line, it may be understood that a secondary audio-optical data structure (2) may have two or more distinct sequences or entries, perhaps such as two or more line entries, or may have individualized cooperative entries. Such multiple lines may provide the capability of cooperative data interaction, by which it may be understood that data content from at least one line may interact with data content from at least one other line to create a functionality. Such a functionality generally may be understood to be directed toward a primary audio-optical data structure (1) to which the multiple line cooperative secondary audio-optical data structure (2) is associated.

For example, a multiple line cooperative secondary audio-optical data structure (2) may have byte location information of primary data content in one line and signature information for such primary data content in another line. In one way of cooperative data interaction, appropriate byte locations and signatures may be coordinated to relevant primary data content. In this manner, the byte location of primary data content that corresponds to a signature value may be determinable such as solely by utilizing the multiple line cooperative secondary audio-optical data structure (2). As a result, the multiple line cooperative secondary audio-optical data structure (2) may create functionality with respect to the primary data content, in this case by locating information in the primary data content that corresponds to a signature value.

While for simplicity this example has involved merely byte locations and signatures in two lines of a multiple line cooperative secondary audio-optical data structure (2), it is noted that the multiple line cooperative secondary audio-optical data structure (2) is amenable to any number of lines or structures employing any number of types of information interacting in any number of types of manners suitable to create functionality in any number of associated data structures. In a voice mail context, for example, one line of information may describe the occurrence of a word in the voice mail message, while a second line may describe the location of the occurrence within the voice mail message, and the two lines may interact to enable a user to identify and retrieve selected words from the voice mail message. Similarly, in a data mined video footage context, the occurrence of a scene or event may be identified within the video footage, and a description of the scene or event may be stored in one line and a location of the scene or event within the footage may be stored in a second line.

In other embodiments, a secondary audio-optical data structure (2), as may be shown for some embodiments by the rectangle in FIGS. 1-7 may be a pre-shaped data structure. By pre-shaping a secondary audio-optical data structure (2), it may be understood that data content may be populated within a secondary audio-optical data structure (2) in a predefined form. For example, pre-shaping a secondary audio-optical data structure (2) to accompany a primary audio-optical data structure (1) consisting of a voice mail message may involve prompting a user for pre-shaped input such as name information, address information, and subject line information to accompany the voice mail message. In this manner, it may be seen that the pre-shaped secondary audio-optical data structure (2) contains information relevant to and enhancing the versatility of the primary audio-optical data structure (1). Of course, it may be appreciated that this example is provided merely as a simple illustration of the great variety of embodiments by which pre-shaping of a secondary audio-optical data structure (2) may be accomplished. For example, in user prompting embodiments, prompting may be accomplished in any suitable manner, such as by speech prompts, visual prompts, menu driven prompts, and the like. Moreover, it may be appreciated that pre-shaped secondary audio-optical data structures (2) in certain embodiments may be standardized, for example so that even a number of different pre-shaped secondary audio-optical data structures (2) associated to a number of different primary audio-optical data structures (1) may nevertheless have a standardized form. Such a standardized form may assist in efficiently working with such pre-shaped secondary audio-optical data structures (2), for example by making it easier to locate desired information within any individual secondary audio-optical data structure (2) due to their common format.

Embodiments may also include post-shaping the secondary audio-optical data structures (2), as may be shown for some embodiments by the rectangles seen in FIGS. 1-7. By post-shaping a secondary audio-optical data structure (2), it may be understood that data content may be populated within a secondary audio-optical data structure (2) in response to a primary audio-optical data structure (1) that has already been or is being established. One embodiment that may involve post-shaping, for example, may be data mining. Data mining generally may be understood to involve searching data content for the occurrence of certain information, and perhaps retrieving that information. In a data mining embodiment, post-shaping a secondary audio-optical data structure (2) may involve adding data mined content retrieved from a primary audio-optical data structure (1) to a secondary audio-optical data structure (2). In this manner, it may be seen that the format of the secondary audio-optical data structure (2) may evolve in response to the data mining efforts, and thus may be a post-shaped secondary audio-optical data structure (2). Of course, it may be understood that this particular example of data mining, and in fact the concept of data mining in general, merely are illustrative of the concept of a post-shaped secondary audio-optical data structure (2), and that post-shaping a secondary audio-optical data structure (2) of course may take any form appropriate to exploit a functionality of a primary audio-optical data structure (1).

Data content in various embodiments, such as may be shown for some embodiments within the rectangles in FIGS. 1-7, similarly may be appreciated to be available in any of a number of forms suitable to the purpose for which such data content is utilized. For example, embodiments may include conceptual data content, non-time indexed data content, non-text indexed data content, and metadata content. The term conceptual data content may be understood to encompass data content of a substantive nature, for example as opposed to data content that merely embodies formatting information, location information, or other information not related to the substance of the data itself. The term non-time indexed data content may be understood to encompass data content that is arranged in an order than does not depend on runtime information or time based functionality to establish the order. The term non-text indexed data content may be understood to include data content that is arranged in an order that does not depend on textual information to establish the content or perhaps even order. Examples of data content in various embodiments may include, but not be limited to, phoneme content, speech content, audio content, music content, non-speech audio content, video content, slide show content, and the like.

Various embodiments also may include various kinds of data processors, as may be variously shown for some embodiments in FIGS. 1-7. The term data processor may be understood to include perhaps any suitable device for processing data. For example, in some embodiments a data processor may be simply one or more processors as may be utilized by a programmed computer to process computer data. Moreover, data processors in various embodiments perhaps may be denominated according to at least one data processing activity implemented by the data processor, through operation of the data processor, or even through software subroutines or the like. For example, embodiments may include identification processors, location processors, correspondence processors, and the like.

Moreover, various embodiments may include a data output responsive to a data processor, perhaps as may be shown for some embodiments in FIGS. 1-4 and FIG. 6. The term data output may be understood perhaps to include simply an output configured to output information processed in a data processor. For example, in various embodiments a data output perhaps may include devices as varied as printers, monitors, speakers, memory, or other devices capable of outputting data. In some embodiments, a data output may be a selective data output, by which it may be understood that output data may be selected according to one or more appropriate criteria.

Now referring primarily to FIG. 1, embodiments may include a method for accessing sequenced audio-optical data. In various embodiments the method may include establishing a primary sequenced audio-optical data structure (3), populating said primary sequenced audio-optical data structure (3) with primary sequenced audio-optical data content (7), establishing a secondary sequenced audio-optical data structure (4), and populating said secondary sequenced audio-optical data structure (4) with secondary sequenced audio-optical data content (8). These may be shown for some embodiments by the rectangles in FIG. 1. Moreover, it may be appreciated the method may be effected by a sequenced audio-optical data access apparatus or programming, perhaps conceptually as shown.

Embodiments may include arranging such primary sequenced audio-optical data content (7) populated within said primary sequenced audio-optical data structure (3) in a memory unit format (12), as may be shown for some embodiments in FIG. 1. Memory units may be understood to include sub-structures within a data content structure that further arrange data content, for example perhaps by sub-dividing data content into start and stop locations, breaks between portions of data content, or other kinds of data content subdivision. In some embodiments, arranging in a memory unit format (12) may comprise utilizing block sizes, perhaps wherein one block size is used as a single memory unit. Block sizes may be understood to include standard sized memory units, perhaps geared towards use with certain kinds of data content. For example, it may be that .wav files typically use block size arrangements for .wav data content, wherein the block sizes may typically be 512 bytes in size. Accordingly, embodiments may include a memory unit format (12) to which primary sequenced audio-optical data content (7) populated within a primary sequenced audio-optical data structure (3) is arranged. For example, the content of a voice mail message or video footage may be embodied in a .wav file that is subdivided into blocks of 512 bytes in size.

Further embodiments may include relating at least one data element of said secondary sequenced audio-optical data content (8) to at least one medial data element interpolated within said memory unit format (12) of said primary sequenced audio-optical data content (7). The term medial data element may be understood to describe a data element that is located intermediately within a memory unit. In this manner, it may be seen how a medial data element may be interpolated within a memory unit format (12). Moreover, the step of relating may involve creating a functional relationship between the medial data element and a secondary data element such that the secondary data element may be used to generate an effect with respect to the medial data element. In some embodiments, for example, the secondary data element may simply describe a location of the medial data element within the primary sequenced audio-optical data content (7), so that the secondary data element may be used to locate the medial data element. Accordingly, embodiments may include a relational data element configuration (11) configured to relate at least one data element of a secondary sequenced audio-optical data content (8) to at least one medial data element interpolated within a memory unit format (12) of a primary sequenced audio-optical data content (7). This may be shown for some embodiments conceptually by the dotted line of FIG. 1.

Of course, the foregoing merely illustrates one possible relationship, and it may be appreciated that the step of relating may involve developing any of a number of suitable relationships. A further example may include relating exclusive of the boundaries of a memory unit format (12), in which the relationship may be characterized as being established irrespective of such memory unit format (12) boundaries. Another example may involve overlapping the boundaries of a memory unit format (12), in which portions of a medial data element may lie on each side of a memory unit boundary, and the relationship may describe the extent of the medial data element notwithstanding the overlap. Still another example may be uniquely relating, in which the relationship established may be unique to and perhaps uniquely identify the medial data element. A further example may involve relating independently from a memory unit format (12), in which a relationship may be defined by criteria completely independent from those defining the memory unit format (12). Moreover, it may be appreciated that in various embodiments a relational data element configuration (11) may be configured to encompass any of the foregoing attributes.

Embodiments may additionally involve locating at least one medial data element interpolated within a memory unit format (12) of primary sequenced audio-optical data content (7) utilizing at least one related data element of secondary sequenced audio-optical data content (8). Utilizing a secondary data element in this manner of course may involve locating the medial data element based on a relationship established between the two, perhaps as described herein. Accordingly, various embodiments naturally may include a medial data element location processor (9) responsive to a relational data element configuration (11), as may be shown for some embodiments by the line in FIG. 1, and configured to locate at least one medial data element interpolated within a memory unit format (12) of primary sequenced audio-optical data content (7) in relation to the relational data element configuration (11). A voice mail message context, for example, may involve the ability to locate a specific word or phrase directly within the message, even if that word or phrase resides within a block of a .wav file in which the message may be embodied. Similarly, a scene or event within video footage also may be located in such a manner, again even if the scene or event resides within a .wav file block.

Moreover, such step of locating may be flexibly implemented in a variety of modalities. For example, a medial data element may be located in situ, may be separated from surrounding data content, may be located independently from a time indexed basis, and may be located independently from a text indexed basis. Naturally, a medial data element location processor (9) may be configured to encompass each of these attributes.

In some embodiments, further steps may involve accessing said at least one medial data element interpolated within said memory unit format (12) of said primary sequenced audio-optical data content (7). The term accessing may be understood to include simply making a medial data element available for further manipulation, access, or analysis, and may follow from having located the medial data element. Moreover, certain embodiments may involve selectively accessing a medial data element.

Embodiments further may include a data element output (10) responsive to a medial data element location processor (9), as may be shown for some embodiments by the line in FIG. 1. In various embodiments, the data element output (10) may output the location of a medial data element interpolated within primary data content.

In various embodiments, the steps of relating at least one data element, locating said at least one medial data element, and accessing said at least one medial data element may include additional constituent steps. For example, the steps in certain embodiments may include utilizing a signature, utilizing a byte order, or utilizing a phoneme. Moreover, in various embodiments a relational data element configuration (11) and a medial data element location processor (9) may be included as parts of a data manipulation system. For example, in certain embodiments a relational data element configuration (11) and a medial data element location processor (9) may comprise a signature manipulation system (35), a byte order manipulation system (36), or a phoneme manipulation system (37). This may be conceptually shown for some embodiments by the dotted line in FIG. 1.

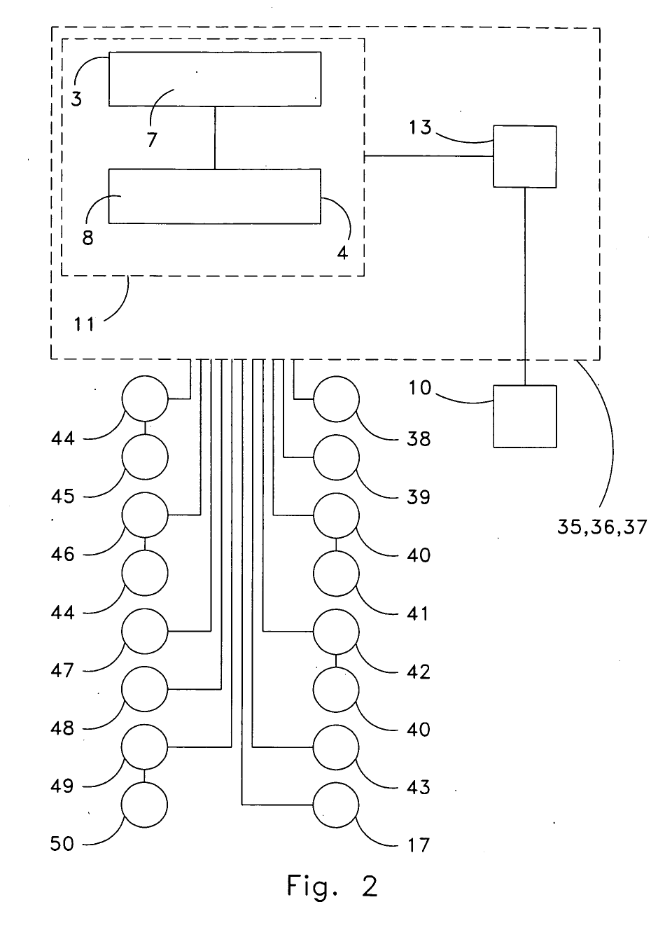

Now referring primarily to FIG. 2, embodiments may include a method for accessing sequenced audio-optical data. In various embodiments the method may include establishing a primary sequenced audio-optical data structure (3), populating said primary sequenced audio-optical data structure (3) with primary sequenced audio-optical data content (7), establishing an integrated secondary sequenced audio-optical data structure (4), and populating said integrated secondary sequenced audio-optical data structure (4) with secondary sequenced audio-optical data content (8). These may be shown for some embodiments by the rectangles in FIG. 2. Moreover, it may be appreciated that in various embodiments the method may be effected by a sequenced audio-optical data access apparatus.

Embodiments may include relating at least one data element of integrated secondary sequenced audio-optical data content (8) to at least one data element of primary sequenced audio-optical data content (7). This may be shown for some embodiments by the line between the rectangles in FIG. 2. The step of relating may involve creating a functional relationship between the two data elements such that an action taken with respect to the secondary data element may result in an effect with respect to the primary data element. In some embodiments, for example, the secondary data element may simply describe a location of the primary data element within the primary sequenced audio-optical data content (7), so that the secondary data element may be used to locate the medial data element. Accordingly, embodiments may include a relational data element configuration (11), as may be shown for some embodiments by the dotted line in FIG. 2, configured to relate at least one data element of an integrated secondary sequenced audio-optical data content (8) to at least one data element of a primary sequenced audio-optical data content (7). A voice mail message, for example, may have an associated header file in which the locations for certain words within the voice mail message are stored in the header file. Similarly, video footage may have an associated header file in which the locations of certain scenes or events are stored.

Of course, the foregoing merely illustrates one possible relationship, and it may be appreciated that the step of relating may involve developing any number of relationships. For example, in various embodiments, the step of relating may involve uniquely relating, relating on a content basis, structurally relating, algorithmically relating, relating based on an information meaning, or relating based on format. Naturally, a relational data element configuration (11) in various embodiments may be configured to encompass any of the foregoing attributes.

Embodiments may further include interstitially accessing said at least one data element of said primary sequenced audio-optical data content (7) utilizing said at least one data element of said integrated secondary sequenced audio-optical data content (8). The term accessing may be understood to include simply making a medial data element available for further manipulation, and the term interstitially accessing may be understood to include accessing a data element located in an intervening space such as anywhere between boundaries within a data structure. For example, embodiments may involve simply selecting a start location within a primary sequenced audio-optical data content (7), selecting a stop location within a primary sequenced audio-optical data content (7), and accessing a data element between said start location and said stop location. It may be appreciated that such start locations and stop locations may be selected based on any appropriate criteria for a given application. In some applications, for example, a start location simply may be the beginning of primary data content, a stop location simply may be the ending of primary content, and interstitially accessing a data element may be simply accessing the data element within the primary content and exclusive of the start location and the stop location.

Accordingly, embodiments may include an interstitial data element location processor (13) responsive to a relational data element configuration (11), as may be shown for some embodiments by the line in FIG. 2, and configured to interstitially access at least one data element of a primary sequenced audio-optical data content (7). Moreover, in certain embodiments such an interstitial data element location processor (13) may include a start location determination processor, a stop location determination processor, and an intermediate data element access processor. Of course, a start location determination processor may be configured to determine a beginning location of primary sequenced audio-optical data content (7), and a stop location processor may be configured to determine an ending location of primary sequenced audio-optical data content (7). Additionally, an interstitial data element location processor (13) in various embodiments may include a start location exclusive and stop location exclusive interstitial data element location processor (13).

Moreover, in various embodiments the step of interstitially accessing may involve accessing a data element in situ relative to surrounding primary sequenced audio-optical data content (7), separating a data element from surrounding primary sequenced audio-optical data content (7), accessing a data element independently from a time indexed basis, accessing a data element independently from a text indexed basis, and perhaps selectively accessing a data element. Additionally, the step of utilizing a secondary data element in connection with interstitially accessing a primary data element of course may be based on a relationship established between the two, perhaps as hereinbefore described. Naturally, an interstitial data element location processor (13) in various embodiments may be configured such as by programming, subroutines, or even instruction codes to encompass any or all of these attributes.

Embodiments further may include a data element output (10) responsive to an interstitial data element location processor (13), as may be shown for some embodiments by the line in FIG. 2. In various embodiments, the data element output (10) may output an interstitial location of a data element located within primary data content. For example, a voice mail message context may include a cell phone in which the output may be a screen of the cell phone, a speaker of the cell phone, or perhaps even a memory of the cell phone. Similarly, a data output element for data mined video footage may simply be a read/write device capable of writing data mined content to a memory or perhaps even to a header file.

Moreover, in various embodiments, the steps of relating at least one data element and interstitially accessing said at least one data element may include additional constituent steps. For example, the steps in certain embodiments may include utilizing a signature, utilizing a byte order, or utilizing a phoneme. Moreover, in various embodiments a relational data element configuration (11) and an interstitial data element location processor (13) may be included as parts of a data manipulation system. For example, in certain embodiments a relational data element configuration (11) and an interstitial data element location processor (13) may comprise a signature manipulation system (35), a byte order manipulation system (36), or a phoneme manipulation system (37). These may be conceptually shown for some embodiments by the dotted line in FIG. 2.

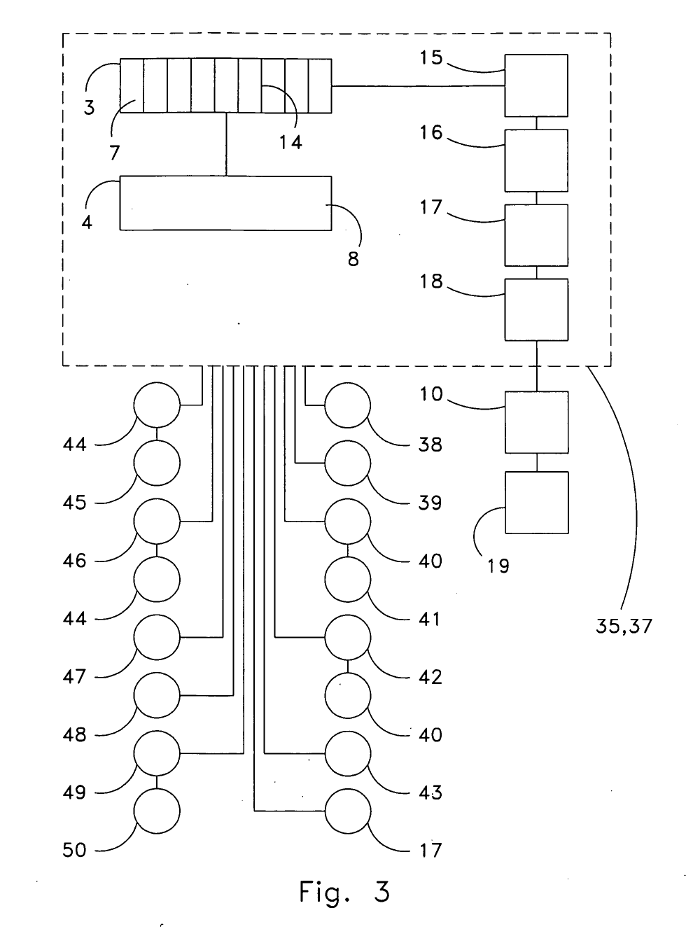

Now referring primary to FIG. 3, embodiments may include a method for locating sequenced audio-optical data. In various embodiments the method may include establishing a primary sequenced audio-optical data structure (3) and populating said primary sequenced audio-optical data structure (3) with primary sequenced audio-optical data content (7). These may be shown for some embodiments by the rectangles in FIG. 3. Moreover, it may be appreciated that in various embodiments the method may be effected by a sequenced audio-optical data location apparatus.

Some embodiments may include arranging primary sequenced audio-optical data content (7) of a primary sequenced audio-optical data structure (3) in a byte order. The term byte order may be understood to include an order in which two or more bytes may be arranged. It may be appreciated that such a byte order arrangement (14), as may be shown for some embodiments within the rectangle of FIG. 3, may be arranged in any manner suitable for a given application, including but not limited to an order that conforms to the structural requirements of a data structure, an order that conforms to the processing requirements of a computer system, or an order that is coordinated to meaningful information of the data content embodied by the bytes of the byte order. Moreover, in some embodiments bytes may be arranged into words, and a byte order may be a word order. Accordingly, embodiments may include a byte order arrangement (14) of primary sequenced audio-optical data content (7) populated within a primary sequenced audio-optical data structure (3).

Embodiments may further include identifying a desired data element for which a location within primary sequenced audio-optical data content (7) is sought to be determined. At this stage, it may not be necessary to know if such a desired data element actually exists with the data content. Rather, such step of identifying may involve perhaps merely ascertaining what a desired data element might be. Accordingly, it may be appreciated that such step of identifying may be effected in any appropriate manner from which a desired identification may be obtained, including such as by user identifying, automatically identifying, or perhaps even uniquely identifying. Moreover, embodiments accordingly may include a desired data element identification processor (15), as may be shown for some embodiments connected to the primary sequenced audio-optical data structure (3) in FIG. 3, which of course may be understood to be configurable to achieve any of the foregoing attributes. Identifying a desired data element for a voice mail message, for example, simply may involve a user desiring to see if any received voice mail messages contain a name or telephone number the user may want to receive. In the context of data mined video footage, identifying a desired data element may involve determining for example that only day scenes or night scenes are likely to contain the desired data element.

Certain embodiments may include the step of creating a byte order representation of a desired data element. The term byte order representation may be understood to include byte orders having a sufficiently close identity to a desired data element such that the same criteria used to identify the byte order representation will also serve to identify the desired data element. It may be appreciated that a byte order representation may be created in any manner appropriate for a given application. For example, embodiments may involve creating a byte order representation from user generated input, or may involve automatically generating a byte order representation. In some embodiments, perhaps where the byte order of a desired data element may be known, creating a byte order representation simply may involve copying a byte order corresponding to a desired data element. In other embodiments, perhaps where the byte order of a desired data element may not be known, creating a byte order representation may involve modeling a desired data element. It may be appreciated that such modeling may be accomplished according to any suitable criteria sufficient to model such a desired data element. Moreover, creating a byte order representation need not necessarily involve representing an entire data element. In some circumstances, a data element may be readily distinguished based on one or more constituent attributes of the data element. Accordingly, embodiments may involve simply creating a byte order representation of an attribute of a desired data element. Moreover, various embodiments accordingly may include a byte order representation generator (16) responsive to a desired data element identification processor (15), as may be shown for some embodiments by the line in FIG. 3, and configured to create a byte order representation of a desired data element. Of course, such configuration may be understood to further include any of the foregoing attributes.

Some embodiments may involve comparing a byte order representation of a desired data element to a byte order arrangement (14) of primary sequenced audio-optical data content (7). The term comparing may be understood to involve analyzing the byte order representation and the byte order arrangement (14) to note similarities and differences. It may be appreciated that the step of comparing may be effected in any appropriate manner to effect such a comparison. In some embodiments, the step of comparing may involve comparing by byte order. Moreover, various embodiments accordingly may include a byte order comparator (17) responsive to a byte order representation generator (16), as may be shown for some embodiments by the line in FIG. 3, and configured to compare a byte order representation of a desired data element to a byte order arrangement (14) of primary sequenced audio-optical data content (7).

Moreover, in certain embodiments the step of comparing may be effected at rates faster than may be conventionally achievable for audio-optical data. Such faster rates may be possible because the step of comparing may be performed on a byte order basis rather than on conventional bases, such as perhaps audiogram comparisons or textual comparisons. In particular, some conventional comparison processes may be limited to the playback rate of the audio-optical data content being compared. Accordingly, embodiments may involve comparing a byte order representation at a rate faster than a playback rate of the primary sequenced audio-optical data content (7). Moreover, conventional comparison processes for audio-optical data may not efficiently utilize the processing speed of a computing device used to accomplish the comparison. This may be because conventional comparison processes may result in substantial processor idle times while data content is being compared, again perhaps due to limitations of conventional comparison bases. Accordingly, embodiments may involve efficiently utilizing the processing speed of a computing device used to accomplish said step of comparing, perhaps including substantially reducing or eliminating processor idle times due to comparing by byte order.

In addition, comparing by byte order may involve sequentially comparing a byte order of primary sequenced audio-optical data content (7) to a byte order representation of a desired data element. In some embodiments, this may involve simply reviewing the bytes of primary sequenced audio-optical data content (7) in sequence and comparing these bytes to the byte order representation of the desired data element. Of course, it may be appreciated that such reviewing may be accomplished in any appropriate sequence, such as the entire sequence of the data content, sequences involving merely selected portions of the data content, or perhaps even sequences of non-contiguous bytes of the data content, for example perhaps as determined by a comparison algorithm. For example, the entire byte order of a voice mail message may be reviewed sequentially on a byte by byte basis to see if the byte order representation corresponding to a word that is being searched for may occur within the message. Similarly, a sequential comparison of video footage undergoing data mining may involve reviewing all bytes within the video footage in a sequential order to see if the order of any bytes therein correspond to a byte order representation of a scene or event that is being searched for.

Moreover, it may be appreciated that the step of comparing may be conducted in any manner appropriate for a given application. For example, various embodiments may involve the steps of directly comparing, algorithmically comparing, hierarchically comparing, conceptually comparing, structurally comparing, and comparing based on content. Additionally, a byte order comparator (17) in various embodiments of course may be configured to effect any of the types of comparisons herein described.

Embodiments also may involve determining if a byte order representation of a desired data element corresponds to at least one byte order location within primary sequenced audio-optical data content (7). Naturally, such a determination in some embodiments may be made utilizing the steps of identifying a desired data element, creating a byte order representation, and comparing said byte order representation as described. Moreover, it may be appreciated that the specific type of correspondence may be selected based on any criteria that may be suitable for a given application, and the location parameters also may be selected based on any criteria that may be suitable for a given application. For example, in some embodiments such a determination may be made simply by matching a byte order representation to at least one byte order location. Again, the particular criteria for concluding that a match exists may be selected to meet the needs of a given application. In other embodiments, the step of determining may include determining in situ relative to primary sequenced audio-optical data content (7), separating a byte order location from surrounding primary sequenced audio-optical data content (7), determining independently from a time indexed basis, and determining independently from a text indexed basis. Accordingly, various embodiments may include a correspondence processor (18) responsive to a byte order comparator (17), as may be shown for some embodiments by the line in FIG. 3, and configured to determine if a byte order representation of a desired data element corresponds to at least one byte order location within primary sequenced audio-optical data content (7). Of course, such a correspondence processor (18) may be understood to be configurable to include any of the foregoing attributes.

Certain embodiments also may include the step of inferring a location of a desired data element within primary sequenced audio-optical data content (7). This step simply may follow from the steps of identifying a desired data element, creating a byte order representation, comparing said byte order representation, and determining a correspondence, and merely may provide the basis for concluding that the desired data element exists within the primary sequenced audio-optical data content (7) at the location determined. Naturally, embodiments also may include a desired data element location inference processor (19), as may be shown for some embodiments in FIG. 3 connected to a data element output (10). For example, once a byte order for a desired word in a voice mail message or a desired scene or event within video footage has been determined to correspond to a byte order representation of the same, it may be possible to infer that the desired information may be found within the voice mail message or video footage at that location.

Embodiments further may include a data element output (10) responsive to a correspondence processor (18), as may be shown for some embodiments by the line in FIG. 3. In various embodiments, the data element output (10) may output correspondence information relative to whether a byte order representation in fact corresponds to a byte order location, perhaps as described herein.

Moreover, in various embodiments, the steps of identifying a desired data element, creating a byte order representation, comparing said byte order representation, and determining if said byte order representation corresponds may include additional constituent steps. For example, the steps in certain embodiments may include utilizing a signature, utilizing a byte order, or utilizing a phoneme. Moreover, in various embodiments a desired data element identification processor (15), a byte order representation generator (16), a byte order comparator (17), and a correspondence processor (18) may be included as parts of a data manipulation system. For example, in certain embodiments a desired data element identification processor (15), a byte order representation generator (16), a byte order comparator (17), and a correspondence processor (18) may comprise a signature manipulation system (35) or a phoneme manipulation system (37). This may be shown for some embodiments conceptually by the dotted line in FIG. 3.

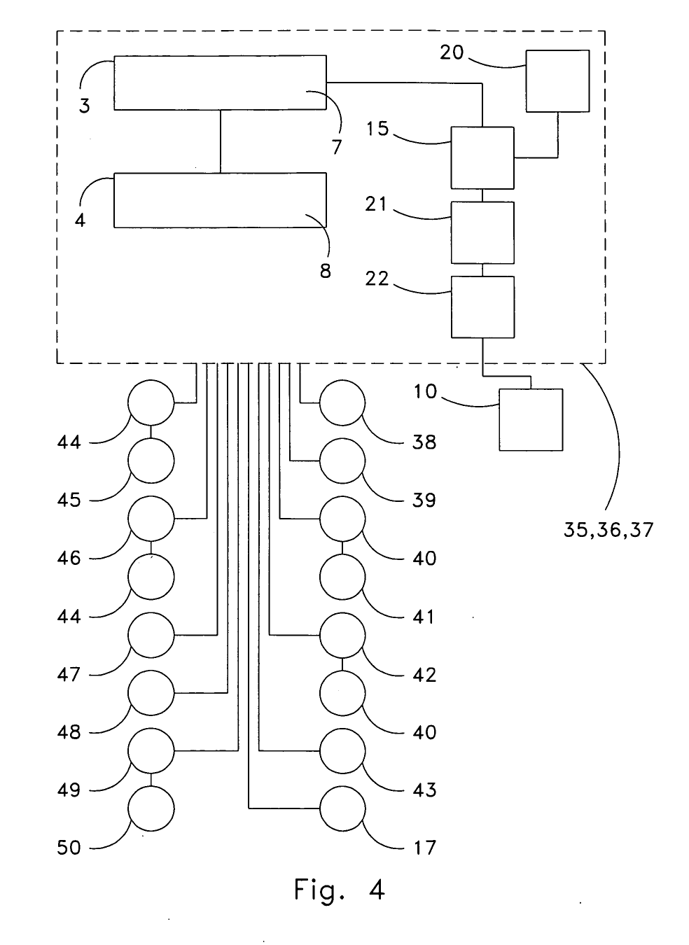

Now referring primarily to FIG. 4, embodiments may include a method for retrieving contextual sequenced audio-optical data. In various embodiments the method may include establishing a primary sequenced audio-optical data structure (3) and populating the primary sequenced audio-optical data structure (3) with primary sequenced audio-optical data content (7). These may be shown for some embodiments by the rectangles in FIG. 4. Moreover, it may be appreciated that in various embodiments the method may be effected by a contextual sequenced audio-optical data retrieval apparatus.

Certain embodiments may involve identifying a desired data element of primary sequenced audio-optical data content (7) for which associated contextual sequenced audio-optical data content within the primary sequenced audio-optical data content (7) is sought to be retrieved. This step of identifying may involve simply ascertaining what such a data element may be so that it may be searched for within the data content, perhaps without even knowing with certainty whether the data element actually exists in the data content. It may be appreciated that this step of identifying may be effected in any suitable manner, including perhaps user identifying the desired data element or automatically identifying the desired data element. Additionally, it may be appreciated that such a desired data element may be of any suitable type of desired data content, including for example a pixel data element, a music data element, a non-speech audio data element, a video frame data element, a digital data element, a phoneme data element, or the like.

Moreover, the term associated contextual content may be understood to include data content that provides contextual meaning for a desired data element. Examples of contextual content may include the sentence in which a word appears, the paragraph in which a sentence appears, the scene in which a video frame appears, and the like. Of course, these examples are merely illustrative of the concept of contextual content, and it may be appreciated that contextual content may be content of any suitable type for a given application. Moreover, various embodiments accordingly may include a desired data element identification processor (15), such as may be shown for some embodiments connected to a primary sequenced audio-optical data structure (3) in FIG. 4, which naturally may be configured to include any of the foregoing attributes. In a voice mail message for which the occurrence of a particular word may be sought, for example, associated contextual content may include perhaps the sentence in which the word appears or perhaps only sentences in which the word appears next to a particular name or location. Data mining of video footage for example may include searching for a video frame having pixel values suggestive of a night scene, and then identifying all preceding and following video frames that have the same pixel values as suggesting video frames of the same night scene.

Some embodiments may involve defining at least one contextual indicia related to a desired data element. The term contextual indicia may be understood to include any indicator capable of indicating contextual data content that may be relevant to a desired data element. By the term defining, it may be understood that a contextual indicia may be defined by any appropriate criteria suitable to return contextual content related to a desired data element in a desired form or manner. For example, the step of defining a contextual indicia may involve defining a phoneme-based contextual indicia, wherein the contextual indicia may simply be a phoneme or combination of phonemes. Such a step of defining may include defining at least one occurrence of a phoneme-based contextual indicia within data content before a desired data element and defining at least one occurrence of a phoneme-based contextual indicia within data content after the desired data element.

In another example, the step of defining a contextual indicia may involve defining a pause-based contextual indicia. The term pause may be understood to include any appropriate pause in data content, as for example a pause in speech, a pause in music, a pause in a stream of digital data, and the like. Such a step of defining may include defining at least one occurrence of a pause-based contextual indicia within data content before a desired data element and defining at least one occurrence of a pause-based contextual indicia within data content after a desired data element. For example, searching for the occurrence of a word in a voice mail message may involve finding the word, then backing up to the first pause that occurs before the word and forwarding to the first pause that occurs after the word in order to retrieve the sentence or phrase within which the word appears.

Further examples may include defining a contextual indicia to be a pixel based indicia, a music based indicia, a non-speech audio based indicia, a video based indicia, a digitally based indicia, a content based indicia, a structure based indicia, an algorithmically based indicia, a meaning based indicia, a format based indicia, or the like. Additionally, defining a contextual indicia may involve contiguously defining or non-contiguously defining the contextual indicia with respect to a desired data element. The term contiguously defining may be understood to include defining a contextual indicia to occur within a continuously connected portion of data content relative to a desired data element, while the term non-contiguously may be understood to include defining a contextual indicial to be separated from a desired data element within such data content, as perhaps by intervening unrelated data content. Moreover, it may be appreciated that a contextual indicia may be varied based on variable input. For example, such variable input may in various embodiments specify the form of the contextual indicia, the location of the contextual indicia relative to a desired data element, and so forth. Of course, various embodiments accordingly may include a contextual indicia designator (20) responsive to a desired data element identification processor (15), as may be shown for some embodiments by the line in FIG. 4, and configured to designate at least one contextual indicia related to a desired data element. Naturally, such a contextual indicia designator (20) may be configured in various embodiments to include defining a contextual indicia in any of the manners described herein.

Embodiments may further include the steps of locating a desired data element within primary sequenced audio-optical data content (7) and locating a contextual indicia related to the desired data element within such primary sequenced audio-optical data content (7). Naturally, embodiments may accomplish such steps of locating in accordance with the steps of identifying a desired data element and defining at least one contextual indicia, as previously described. Where a contextual indicia is a phoneme, for example, the steps of locating may involve locating the desired data element, then locating some occurrence of the phoneme indicia relative to the desired data element and consistent with the criteria to which the phoneme indicia was defined. Similarly, where the contextual indicia is a pause, the step of locating may involve locating the desired data element, then locating some occurrence of the pause indicia relative to the desired data element and consistent with the criteria to which the pause indicia was defined.

However, it will be appreciated that these example are merely illustrative of the manner in which the steps of locating may be accomplished, and that locating may be accomplished in any suitable manner appropriate for a given application. For example, the steps of locating may involve locating the desired data element and the contextual indicia in situ relative to surrounding data content, separating the desired data element and the contextual indicia from the surrounding data content, locating the desired data element and the contextual indicia independently from a time indexed basis, locating the desired data element and the contextual indicia independently from a text indexed basis, and the like.

Accordingly, embodiments may include a desired data element location processor (21) responsive to a desired data element identification processor (15), as may be shown for some embodiments by the line in FIG. 4, and configured to locate a desired data element within primary sequenced audio-optical data content (7), as well as a contextual indicia location processor (22) responsive to a desired data element location processor (21), as may be shown for some embodiments by the line in FIG. 4, and configured to locate at least one contextual indicia related to a desired data element within primary sequenced audio-optical data content (7). Moreover, such a desired data element location processor (21) and a contextual indicia location processor (22) naturally may be further configured to include any of the attributes described herein.

Some embodiments may further involve retrieving a desired data element within an associated contextual sequenced audio-optical data content by utilizing at least one contextual indicia. Such step of retrieving may be understood to include perhaps simply making the desired data element available for further manipulation or access with its associated contextual content, for example perhaps by presenting the desired data element with its associated contextual content to a user in a user-interpretable form. In some embodiments, this step of retrieving may follow simply from the steps of locating a desired data element and locating a contextual indicia, as described herein. For example, where the contextual indicia is a phoneme, contextual content may be retrieved perhaps on a location basis relative to the location of the phoneme indicia and the desired data element. Similarly, where the contextual indicia is a pause, contextual content may be retrieved perhaps on location basis relative to the location of the pause indicia and the desired data element. When data mining video footage, for example, the occurrence of a scene or event perhaps may be retrieved in context with related preceding or following video frames, so that the scene or event may be reviewed by a viewer within the context in which the scene or event occurred.

However, it will be appreciated that these examples are merely illustrative of the manner in which contextual data may be retrieved, and that such retrieval may be accomplished by utilizing a contextual indicia in any suitable manner appropriate for a given application. For example, embodiments may involve retrieving contextual data content in various arrangements. Some embodiments may include retrieving substantially all data elements between said desired data element and said contextual indicia, while other embodiments may involve retrieving disparate portions of data content, for example as may be the case when multiple contextual indicia are used and contextual content is defined to be content located proximately to the indicia. Examples may further include retrieving contextual content in the form of user interpretable meaningfully associated information, for example words, phrases, sentences, or other user interpretable content that embodies a conceptually complete meaning. As these examples illustrate, a contextual indicia may be used in various embodiments to retrieve contextual data content with a high degree of versatility.

Embodiments further may include a data element output (10) responsive to a desired data element location processor (21) and a contextual indicia location processor (22), as may be shown for some embodiments by the lines in FIG. 4. In various embodiments, such a data element output (10) may be configured to output a desired data element within an associated contextual sequenced audio-optical data content. For example, such output may include user interpretable meaningfully associated information relative to the desired data element, which in embodiments perhaps may include words, phrases, sentences, or perhaps other kinds of conceptually complete meanings. Further examples may include outputting perhaps substantially all data elements within a primary sequenced audio-optical data content (7) between a desired data element and at least one contextual indicia. Moreover, it may be appreciated that the foregoing examples are merely illustrative, and that a data element output (10) in various embodiments may be configured to output any contextual content as may be described herein. For example, a voice mail message context may include a cell phone in which the output may be a screen of the cell phone, a speaker of the cell phone, or perhaps even a memory of the cell phone. Similarly, a data output element for data mined video footage may simply be a read/write device capable of writing data mined content to a memory or perhaps even to a header file.

Moreover, in various embodiments, the steps of locating a desired data element, locating a contextual indicia, and retrieving a desired data element within an associated contextual data content may include additional constituent steps. For example, the steps in certain embodiments may include utilizing a signature, utilizing a byte order, or utilizing a phoneme. Moreover, in various embodiments a desired data element location processor (21) and a contextual indicia location processor (22) may be included as parts of a data manipulation system. For example, in certain embodiments a desired data element location processor (21) and a contextual indicia location processor (22) may comprise a signature manipulation system (35), a byte order manipulation system (36), or a phoneme manipulation system (37). These may be shown for some embodiments conceptually by the dotted line in FIG. 4.

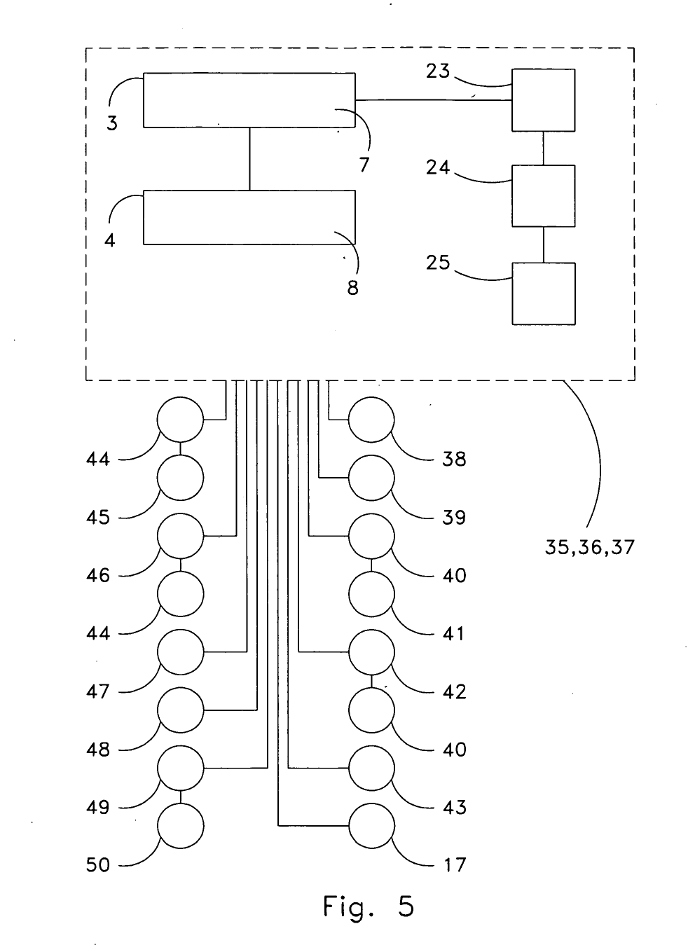

Now referring primarily to FIG. 5, embodiments may include a method for storing phoneme data. Moreover, it may be appreciated that in various embodiments the method may include a phoneme data storage apparatus. Certain embodiments may involve user generating speech data and automatically analyzing the user generated speech data on a phoneme basis. By analyzing on a phoneme basis, it may be understood that the analysis may incorporate the use of phonemes that correspond to or occur within the speech. Moreover, it may be appreciated that such analysis may be effected in any number of forms or manners consistent with utilizing a phoneme basis. For example, such analysis may involve utilizing an audiogram analysis, which perhaps may include correlating audiograms to phonemes. In another example, such analysis may involve utilizing a digital analysis, which perhaps may include correlating digital data to phonemes. In further examples, such analysis may involve a phoneme analysis substantially at the time speech is generated, or may involve storing the speech and analyzing phonemes at a later time. Examples also may include selectively analyzing phonemes, as perhaps by using a user generated selection of the speech to analyze or perhaps by using an automatically generated selection of the speech to analyze. Of course, various embodiments accordingly may include an automatic phoneme based speech data analysis processor (23) configured to automatically analyze speech data on a phoneme basis, as may be shown for some embodiments in FIG. 5 connected to a primary sequenced audio-optical data structure (3). Naturally, such a phoneme based speech data analysis processor may be configured to encompass any of the foregoing attributes. With reference to voice mail messages, for example, an automatic phoneme based speech data analysis processor may analyze speech in a recorded voice mail message by examining the constituent phonemes that make up the recorded message.

Embodiments further may involve automatically identifying at least one constituent phoneme of user generated speech data based on the step of automatically analyzing said user generated speech data on a phoneme basis. A constituent phoneme may be understood to include a phoneme content of speech that is recognized by its phoneme nature. In particular, constituent phonemes may be distinguished from mere audio data corresponding to speech, wherein the audio data is not specifically associated to a phoneme, perhaps even where the audio data may happen to coincide with the occurrence of a phoneme. Moreover, the quality of being recognized specifically by their phoneme nature may allow constituent phonemes in various embodiments to be processed on a phoneme basis, as perhaps may be distinguished from processing speech content merely on an audio basis, such as may occur when processing audio files based on the analog wave function corresponding to the audio information. Of course, various embodiments accordingly may include an automatic constituent phoneme identification processor (24) responsive to an automatic phoneme based speech data analysis processor (23), as may be shown for some embodiments by the line in FIG. 5, and configured to automatically identify at least one constituent phoneme of speech data.

The term identifying may be understood to involve creating a capability to recognize such a constituent phoneme apart from other phoneme content. Naturally such identification may involve identifying a constituent phoneme based on attributes developed during the step of analyzing. However, it may be appreciated that such identification may effected in any suitable form or manner consistent with identifying on a phoneme basis. For example, the step of identifying in various embodiments may involve identifying independently from a time indexed basis, identifying independently from a text indexed basis, or uniquely identifying such a constituent phoneme. Of course, an automatic constituent phoneme identification processor (24) in various embodiments may be configured to encompass any of the foregoing attributes.

Various embodiments may involve automatically storing a constituent phoneme of user generated speech data. The term storing may be understood to include maintaining information corresponding to a constituent phoneme in a stable form, such that it may be retrieved substantially intact at a later time for further manipulation. In various embodiments, the step of storing may involve ephemeral storage, such as may be exemplified by processes such as computer RAM storage, or may perhaps involve long term storage, such as may be exemplified by processes such as database storage. Naturally, embodiments accordingly may include an automatic constituent phoneme memory (25) responsive to an automatic constituent phoneme identification processor (24), as may be shown for some embodiments by the line in FIG. 5, and configured to automatically store at least one constituent phoneme of speech data.

In certain embodiments, the step of storing may involve storing at least one constituent phoneme as a speech information unit. The term speech information unit may be understood to include information that as a unit has a conceptually complete meaning when presented as speech. For example, a speech information unit may include but not be limited to a word, a phrase, a sentence, a verbal presentation, or perhaps any other user interpretable conceptually complete meaning. Accordingly, it may be seen that a speech information unit may be made up of several phonemes, indeed the requisite number of phonemes required to give coherent meaning to the speech information unit. Moreover, some embodiments may utilize multiple speech information units, perhaps selectively arranged according to any suitable criteria for a given application utilizing such speech information units.

Embodiments may also include automatically storing a constituent phoneme with associated data. For example, certain embodiments may involve storing data associated to a constituent phoneme in a secondary sequenced audio-optical data structure (4), or perhaps even storing the constituent phoneme itself in a secondary sequenced audio-optical data structure (4) in association to data in a primary sequenced audio-optical data structure (3), as may be shown for some embodiments by the rectangles in FIG. 5. It may be understood that such associated data may be of any type suitable for a given application involving the constituent phoneme. For example, in various embodiments, such associated data may include but not be limited to content associated data, structurally associated data, algorithmically associated data, meaning associated data, format associated data, and the like. Moreover, various embodiments may involve providing functionality to such a stored constituent phoneme via the associated data. Such functionality may include taking an action with regard to the associated data that generates information about or a result relevant to the stored constituent phoneme, perhaps as may be described elsewhere herein.

Some embodiments may involve storing a constituent phoneme for non-output manipulation. The term output manipulation may be understood to involve utilizing a phoneme only as output to a data processing event that has already been executed. One example of output manipulation of a phoneme may involve speech recognition technology, perhaps as wherein text processing is used to identify selected words on a text basis, wherein the words are then converted to phonemes and output so that a user may hear the words as audible speech. By way of contrast, non-output manipulation may involve manipulating phonemes in the data processing event itself, and not merely as output following the conclusion of a data processing event. In this regard, it may be appreciated in some embodiments that phonemes stored for non-output manipulation may be constituent phonemes, to the extent the data processing may require the phonemes to be recognizable and manipulable based on their phoneme identity. Accordingly, the step of storing in various embodiments may involve selecting storage criteria to facilitate storing constituent phonemes for non-output manipulation. Voice mail messages, for example, may be stored on the basis of the constituent phonemes of the recorded speech. The constituent phonemes then may be used in data manipulations such as comparing the constituent phonemes to identify specific words or phrases or using the constituent phonemes to define contextual content. As may be seen, use of the constituent phonemes is not limited merely to audible playback of the recorded speech.

Of course, these examples are intended merely to illustrate certain aspects relating to the form and manner in which a constituent phoneme may be stored. It may be appreciated that constituent phonemes may be stored in any manner suitable for a given application in which the constituent phoneme is to be utilized. For example, in various embodiments, storing a constituent phoneme may involve storing in an audiogram format, storing in a digital format, long term storing, storing in situ relative to surrounding speech content, separating from surrounding speech content, and the like. Moreover, an automatic constituent phoneme memory (25) in various embodiments of course may be configured to encompass any of the storing aspects described herein.

Moreover, in various embodiments, the steps of automatically analyzing, automatically identifying, and automatically storing may include additional constituent steps. For example, the steps in certain embodiments may include utilizing a signature, utilizing a byte order, or utilizing a phoneme. Moreover, in various embodiments an automatic phoneme based speech data analysis processor (23) and an automatic constituent phoneme identification processor (24) may be included as parts of a data manipulation system. For example, in certain embodiments an automatic phoneme based speech data analysis processor (23) and an automatic constituent phoneme identification processor (24) may comprise a signature manipulation system (35), a byte order manipulation system (36), or a phoneme manipulation system (37). These may be shown for some embodiments conceptually by the dotted line in FIG. 5.

Now referring primarily to FIG. 6, embodiments may include a method for structuring audio-optical data. In various embodiments the method may include establishing a primary audio-optical data structure (1) and populating the primary audio-optical data structure (1) with primary sequenced audio-optical data content (7). These may be shown for some embodiments by the rectangles in FIG. 6. Moreover, in various embodiments the method may be effected by an audio-optical data structuring apparatus.

Various embodiments may include determining a start location and a stop location relative to at least a portion of the primary audio-optical data content (5). The terms start location and stop location may be understood to include simply defining portions of the data content to be delimited for a particular purpose, for example, the portion of data content lying between the start location and the stop location. In various embodiments, such start locations and stop locations may perhaps coexist with such data content without disrupting the continuity of the data content, or may perhaps create separations in the data content to define the start or stop location. The step of determining may be understood to include any action that may result in delimitation of the data content into a start location and a stop location. In this manner, it may be appreciated that any technique suitable for creating a start or stop location may be utilized. Accordingly, various embodiments naturally may include a start location determination processor (27) configured to determine a start location relative to at least a portion of primary audio-optical data content (5) and a stop location determination processor (28) configured to determine a stop location relative to such portion of primary audio-optical data content (5), as may be shown for some embodiments by the lines in FIG. 6. Additionally, some embodiments may include a byte location storage processor (29) responsive to a start location determination processor (27) and a stop location determination processor (28), as may be shown for some embodiments by the lines in FIG. 6, and configured to store byte location information of such start locations and stop locations within a secondary audio-optical data structure (2).

Moreover, it may be appreciated that such start locations and stop locations may be determined based on any appropriate criteria for a given application. In some applications, for example, determining a start location simply may involve determining the beginning of primary data content, and determining a stop location simply may involve determining the ending of primary data content. However, it may be appreciated that start and stop locations may be variably determined, for example as based on variable input. For example, start and stop locations in some embodiments may be determined according to signature information, byte order information, or perhaps phoneme information related to the primary data content. In some embodiments, such signature information, byte order information, or phoneme information may be stored in a secondary data structure. Certain embodiments may even involve determining start and stop locations based on the information of the primary data content itself. For example, start and stop locations may be coordinated to the location of a desired data element within primary data content. In this manner, it may be seen that start and stop locations in some embodiments may be used to structure primary data content according to selected attributes of the data content. Moreover, a start location determination processor (27) and a stop location determination processor (28) in various embodiments of course may be configured to encompass any of the foregoing attributes. In a voice mail message context, for example, start and stop locations may be determined to distinguish one message from another message or perhaps even to distinguish content within a message, such as names, locations, or the like. Similarly, in a data mining context for video footage, start and stop locations for example may be selected to correspond to different scenes within the video footage.

Embodiments may further involve selecting a variable memory unit format (26), as may be shown for some embodiments for the rectangle in FIG. 6, for a portion of primary audio-optical data content (5) within a primary audio-optical data structure (1) coordinated to a start location and a stop location. The term memory unit may be understood to include a sub-structure within a data content structure that further arranges data content, for example perhaps by sub-dividing data content into start and stop locations, breaks between portions of data content, or other kinds of data content subdivision. A variable memory unit format (26) may be understood to include a format of memory units into which data content may be subdivided, wherein the size of any individual memory unit may be varied according to selected criteria. For example, some embodiments may involve selecting the size of a memory unit to coordinate with a portion of data content defined by a start location and stop location. Embodiments also may involve selecting the size of a memory unit to match the size of an entire primary data content or perhaps just a portion of primary data content. Moreover, to the degree that conventional memory formats perhaps may be standardized to 512 byte block sizes, a variable memory unit format (26) may be distinguishable in that it may be selected to include memory units having a capacity of perhaps more than 512 bytes or perhaps less than 512 bytes. Of course, the foregoing examples are merely illustrative of the criteria to which a memory unit format may be selected, and it may be appreciated that memory units may be selected based on any suitable criteria to which a memory unit format may be applied to primary data content. Moreover, embodiments naturally accordingly may include a variable memory unit format generator (30) responsive to a start location determination processor (27) and a stop location determination processor (28), as may be shown for some embodiments by the lines in FIG. 6, and may be configured to generate a variable memory unit format (26) for a portion of primary audio-optical data content (5) within a primary audio-optical data structure (1).

Various embodiments may include structuring a portion of primary audio-optical data content (5) within a primary audio-optical data structure (1) by utilizing a selected variable memory unit format (26) coordinated to a start location and a stop location. The term structuring may be understood to include simply providing a structure to data content defined by arranging the data content within variable memory units. In certain embodiments, the aspect of utilizing a selected variable memory unit format (26) coordinated to a start location and a stop location simply may involve selecting a size of a variable memory unit matched to the start location and the stop location. However, it may be appreciated that the step of structuring may be accomplished to any criteria suitable to arranging data content within a variable memory unit format (26). For example, embodiments may involve sizing variable memory units to contain data content of differing sizes so as to eliminate leading data gaps and trailing data gaps. Stated differently, variable memory units may be selected to match the size of the data content they contain, so that no gaps may be formed within the memory units due to a failure of the data content to fill the memory unit to capacity. Similarly, embodiments may include selecting variable memory units to eliminate memory unit format divisions within data content. In some embodiments, it may be possible to contain the entirety of primary data content within a single memory unit. Of course, the foregoing examples are merely illustrative of the uses to which a variable memory unit format (26) may be put. It may be appreciated that variable memory unit formats (26) may selected for any suitable criteria to which data content may be structured. For example, various embodiments may include selecting a variable memory unit format (26) to structure data content independent from a time indexed basis or independent from a text indexed basis.

Embodiments further may include a data content output (31) responsive to a variable memory unit format generator (30), as may be shown for some embodiments by the line in FIG. 6. In various embodiments, such a data content output (31) may output data content in a structure coordinated to a memory unit format generated by a variable memory unit format generator (30). Accordingly, such a data content output (31) in various embodiments may be configured to structure data content as described herein. For example, in a voice mail message context, a data content output may be a cell phone speaker or screen that plays back structured portions of voice mail messages, such as subject line or recipient information. Similarly, a data content output for data mined video footage may be a read/write device that writes the data mined content to an appropriate header file attached to the video footage.

Moreover, in various embodiments, a variable memory unit format (26) may be utilized in conjunction with the step of utilizing a signature, utilizing a byte order, or utilizing a phoneme. Variable memory unit formats (26) in certain embodiments also may be included as parts of a data manipulation system, for example, a signature manipulation system (35), a byte order manipulation system (36), or a phoneme manipulation system (37). These may be shown for some embodiments conceptually by the dotted line in FIG. 6.

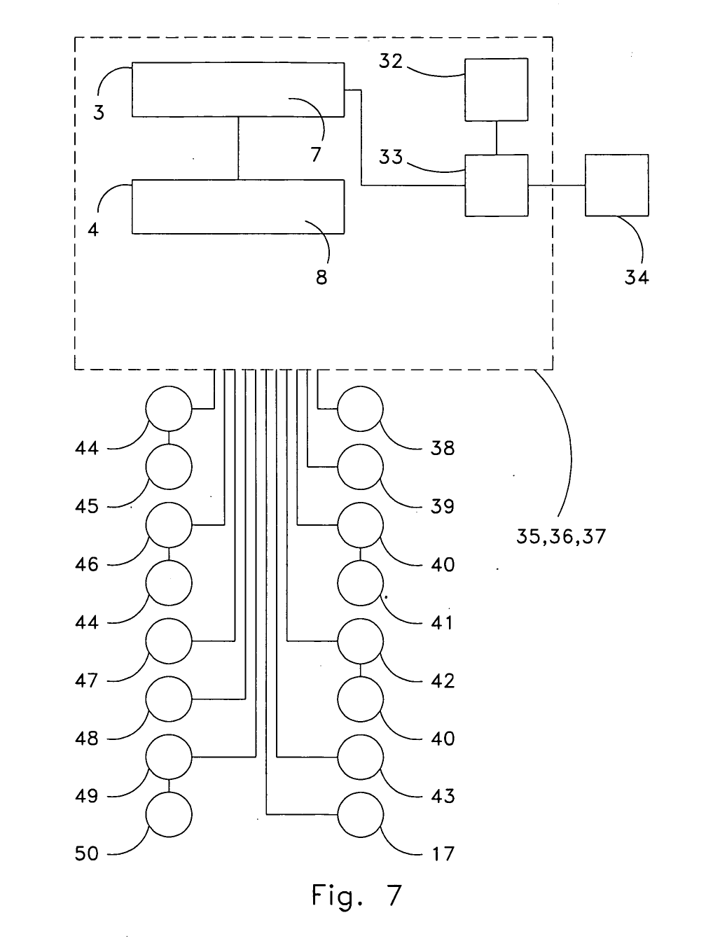

Now referring primarily to FIG. 7, embodiments may include a method for altering sequenced audio-optical data. In various embodiments the method may include establishing a primary sequenced audio-optical data structure (3), populating said primary sequenced audio-optical data structure (3) with primary sequenced audio-optical data content (7), establishing an integrated secondary sequenced audio-optical data structure (4), and populating said integrated secondary sequenced audio-optical data structure (4) with secondary sequenced audio-optical data content (8). These may be shown for some embodiments by the rectangles in FIG. 7. Moreover, in various embodiments the method may be effected by a sequenced audio-optical data alteration apparatus.

Certain embodiments may include determining at least one content alteration criterion related to integrated secondary sequenced audio-optical data content (8). The term content alteration criterion may be understood to include any criterion to which the content of a secondary data structure may be altered. For example, embodiments may include utilizing a variable content alteration criterion. Such a content alteration criterion may vary the criteria by which a secondary data structure may be altered. Examples may include varying a content alteration criterion by signature criteria, byte order criteria, or phoneme criteria. Additionally, a content alteration criterion may be related to secondary data content in any suitable manner sufficient to enable the criterion to be used in altering the secondary data. Examples may include relating on a content basis, structurally relating, algorithmically relating, relating based on information meaning, relating based on format, and the like. Moreover, embodiments may include user determining a content alteration criterion, or perhaps automatically determining a content alteration criterion. Of course, these examples are merely illustrative of the form and manner in which a content alteration criterion may be determined. It may be appreciated that a content alteration criterion may be determined in any suitable manner related to its application to a secondary data structure. Accordingly, various embodiments may include a content alteration criterion generator (32), as may be shown for some embodiments in FIG. 7 connected to a content alteration processor (33), configured to generate at least one content alteration criterion related to an integrated secondary sequenced audio-optical data content (8). Of course, such a content alteration criterion generator (32) further may be configured to encompass any of the foregoing attributes.

Embodiments further may include altering an integrated secondary sequenced audio-optical data content (8) utilizing a content alteration criterion. The term altering may be understood to involve causing a change in the character or composition of a secondary data structure. For example, in various embodiments, altering a secondary data structure may include adding content, deleting content, modifying content, changing content association, expanding structure size, contracting structure size, and the like. Of course, these examples are merely illustrative of the form and manner in which alterations may be made to a secondary data structure. It may be appreciated that any suitable alteration may be made to a secondary data structure for which a content alteration criterion may be used. Additionally, various embodiments of course may include a content alteration processor (33) responsive to a content alteration criterion generator (32), as may be shown for some embodiments by the line in FIG. 7, and configured to alter integrated secondary sequenced audio-optical data content (8).

For example, various embodiments may include repopulating data content within a secondary data structure. The term repopulating may be understood to involve effecting changes to an existing content population within a secondary data structure. For example, repopulating a secondary data structure in certain embodiments may include repopulating with signature content, repopulating with byte order content, or perhaps repopulating with phoneme content. Other examples may include utilizing an integrated secondary sequenced audio-optical data structure (4) having a standardized format and repopulating the integrated secondary sequenced audio-optical data structure (4) having a standardized format with nonstandard integrated secondary sequenced audio-optical data content (8). The term standardized format may be understood to refer to formats for secondary data structures that may tend to comply with standardized criteria, for example as may be inherent to the specifications of the secondary data structure or perhaps as may have been developed through widespread practice over time. The term nonstandard data content may be understood to include content not normally populated within a standardized data structure, for example perhaps because it does not meet the specifications of the secondary data structure or perhaps because it is of a type not normally populated within the secondary data structure. It may be appreciated that repopulating a standardized data structure with nonstandard data content perhaps may increase the functionality of the data structure. As but one example, repopulating with multiple line cooperative secondary data content may increase the utility of a data structure that otherwise may only function with one line. Moreover, a content alteration processor (33) of course may be configured to encompass any of the content alteration aspects described herein.

In various embodiments, the step of altering may involve altering on an ongoing basis. The term ongoing basis may be understood to include continuing alterations made to a secondary data structure that progress or evolve over time. For example, in some embodiments ongoing alterations may involve adding data mined content to a secondary data structure as primary data content is mined on a continuing basis. Similarly, in some embodiments ongoing alterations may include adding pre-shaped data content to a secondary data structure on the fly as primary data content is generated. Of course, these examples are merely illustrative of the form and manner in which ongoing alterations may be made. It may be appreciated that such ongoing alterations may be effected in any suitable manner for which a secondary data structure may be altered, and in embodiments may include an ongoing content alteration processor (33). In a voice mail message context, for example, header information containing information about a voice mail message may be updated as new information about the message is obtained. Similarly, in the data mining of video footage, a header file attached to the video footage may be updated to add new data mined content as ongoing data mining occurs.

Moreover, in various embodiments the step of altering may involve altering on an intermittent ongoing basis. The term intermittent may be understood to include making alterations punctuated by a period or periods of inactivity. Accordingly, it may be seen that the step of altering may not require alterations to be made in a continuous, uninterrupted manner. Rather, embodiments may involve periods of idle time during which a secondary data structure may not be altered, but for which the secondary data structure still may be capable of alteration. Moreover, embodiments further may include an intermittent ongoing content alteration processor (33).

Embodiments may further include maintaining a history of such ongoing alterations. It may be appreciated that such history may be maintained in any appropriate fashion, including perhaps by storing the history within a secondary data structure, and perhaps may include an alteration history compilation processor responsive to an ongoing content alteration processor (33). Moreover, embodiments may include expanding the functionality of a secondary data structure via the step of altering on an ongoing basis. Such expanded functionality in certain embodiments may include the ability to take an action with respect to an altered secondary data structure and effect a result with respect to a primary data structure to which the secondary data structure is associated, and in embodiments may include an altered content expanded functionality processor responsive to an ongoing content alteration processor (33) that may be configured to expand the functionality of integrated secondary sequenced audio-optical data content (8) via such ongoing content alterations. For example, a history maintained for the data mining of video footage may allow a user to review what information has and has not been searched for, perhaps to allow the user to track changes that may have been made to the video footage over time.

It may be desirable in some applications to ensure that a secondary data structure cannot be altered, perhaps in the manners described. Accordingly, embodiments may provide for locking a secondary data structure. The term locking may be understood to include simply a capability to preserve the form and content of a secondary data structure in a manner that cannot be altered. Moreover, embodiments may further include the ability to unlock a secondary data structure, which may be understood to include restoring an ability to make alterations. Embodiments perhaps even may include an ability to selectively lock and unlock a secondary data structure, for example perhaps by using a password or other user identification procedure. Of course, various embodiments accordingly may include a locked content alteration processor (33) and an unlocked content alteration processor (33).

Embodiments may further include preserving the integrity of any remainder secondary data content during a step of altering secondary data content. The term remainder secondary data content may be understood to include secondary data content that is not being altered while other secondary data content within the same secondary data structure is being altered. By preserving the integrity of such remainder secondary content, it may be understood that the remainder secondary data content may be maintained in its original form and location within the secondary data structure even while other secondary data content may be in the process of being altered. In this manner, it may be seen that a secondary data structure may not need to be reformatted or rewritten in its entirety merely because portions of secondary data content with the secondary data structure are desired to be changed. Rather, those portions of secondary data content for which an alteration is desired may themselves be altered, while the remainder of the secondary data structure may be preserved intact. Naturally, embodiments may accordingly include a remainder data integrity preservation processor (34) responsive to a content alteration processor (33), as may be shown for some embodiments by the line in FIG. 7.

Moreover, in various embodiments, the steps of determining at least one content alteration criterion and altering secondary data content may include additional constituent steps. For example, the steps in certain embodiments may include utilizing a signature, utilizing a byte order, or utilizing a phoneme. Moreover, in various embodiments a content alteration criterion generator (32) and a content alteration processor (33) may be included as parts of a data manipulation system. For example, in certain embodiments a content alteration criterion generator (32) and a content alteration processor (33) may comprise a signature manipulation system (35), a byte order manipulation system (36), or a phoneme manipulation system (37). These may be conceptually shown for some embodiments by the dotted line in FIG. 7.

Now referring again to FIGS. 1-7, various embodiments may involve utilizing a signature. The term signature may be understood to include standardized data objects that return a consistent value every time they are related to target data. The term data object simply may refer to the fact that signatures may be information embodied as data. For example, such signature information may include but not be limited to text, phonemes, pixels, music, non-speech audio, video frames, byte orders, digital data, and the like. Such signature data may be capable of manipulation, for example via data processing, just as any other kinds of data are capable of manipulation. Of course, the term target data simply may include any appropriate data to which a signature may be related. By the term standardized, it may be understood that a signature may have a standard form for use in one or more relational events to target data. However, the term standardized should not be construed to limit the possible number of forms a signature may take. Indeed, signatures perhaps may be created on an as-needed basis for use in any suitable application, perhaps to have a standardized form for use in such given applications. Moreover, a consistent value provided by a signature simply may refer to the concept that signatures may represent a control value. Accordingly, in actions performed that utilize a signature, the signature may provide control information relative to the actions for which it is involved, and therefore may return consistent values in the interactions that make up such actions. In this manner, it may be appreciated that signatures may be quite versatile in form and function. Additionally, it may be appreciated that signatures may be utilized by signature manipulation systems (35), as may be shown for some embodiments by the dotted lines in FIGS. 1-7. Such signature manipulation systems (35) may be understood to include any components capable of utilizing signatures in their functionality, and in various embodiments may include signature manipulation systems (35) as described elsewhere herein. In a voice mail message context, for example, a signature manipulation system may include a cell phone and the requisite hardware and software required to create signature representations of speech information in recorded voice mail messages. Similarly, in the data mining of video footage, a signature manipulation system may be the requisite hardware and software required to create signature representations of scenes or events and to store the signatures in an attached header file.

In various embodiments, utilizing a signature may involve relating a signature within secondary sequenced audio-optical data content (8) to primary sequenced audio-optical data content (7), as may be shown for some embodiments by the rectangles in FIGS. 1-7. The term relating may be understood to include taking an action with respect to the signature in the secondary data content and achieving a result with respect to the primary data content, and in various embodiments the step of relating may be effected by a signature manipulation system (35). For example, relating in various embodiments may include directly relating, algorithmically relating, hierarchically relating, conceptually relating, structurally relating, relating based on content, and relating based on format. Moreover, the step of relating in various embodiments may be effected by a signature manipulation system (35), as may be shown for some embodiments by the dotted lines in FIGS. 1-7.

Moreover, it may appreciated that such step of relating may entail many practical uses for a signature. For example, a signature in some embodiments may describe attributes of primary data content and may be associated within a secondary data structure to byte location information for such primary data content within a primary data structure. In this manner, a user searching for desired primary data content simply may be able to scan the signature information contained within a secondary data structure, rather than being required to review all of the information in the primary data content. By using signatures in this manner, it may be possible to quickly locate desired information in primary data content such as words, phrases, sentences, musical objects, pictures, and the like. Conversely, signatures may be used to generate secondary data structures that provide enhanced functionality for primary data content. For example, primary data content may be data mined, and signatures relating to such mined data may be generated and placed in a secondary data structure. In this manner, it may be seen that signatures within a secondary data structure may preserve a record of the data mining of the primary data content, and indeed may provide quick access to the original primary data, for example by storing byte location information in association with the signature.

Additionally, it may be appreciated that the detail and specificity with which information may be retrieved from primary data content by utilizing a signature can be highly focused perhaps simply by creating a signature that represents the information with sufficient detail. In the case of speech, for example, signatures may be constructed perhaps on a phoneme basis to retrieve one particular word, or perhaps two or more words used in association, or perhaps even entire phrases or sentences in association. In this manner, it may be seen that signatures may be constructed with sufficient detail to retrieve perhaps speech information as simple as a name or as complex as a discourse on a topic that uses specialized jargon. Another example may involve signature representations of pictorial information. In this case, signatures may be constructed for example to identify frames of video in which a certain number of pixels meet or exceed a certain value, for example values determined to correspond to a deep blue sky. In this manner, signatures may be used to identify pictures corresponding to daylight, and perhaps may be used to retrieve all frames in a video sequence that may correspond to a daylight scene. Of course, the signature may be constructed to identify pictorial data with even more specificity, for example by specifying pixel values that may represent any number of attributes of pictorial information. In the context of voice mail messages, for example, signatures may be used to represent a word or phrase within recorded speech, and perhaps even may be used in association to represent complex discourses or dialogues involving detailed subject matter. Similarly, when video footage is data mined, signatures may be used to represent certain scenes or events, and perhaps may be combined to allow video frames to be identified on the basis of multiple parameters such as the brightness of the sky, the presence of a caption, the audio of a speaker, and the like.

Of course, the foregoing examples are merely illustrative of the form and manner in which signatures may be used. It may be appreciated that signatures may be created and used according to any suitable criteria to which data may be formed and processed on a signature basis.

For example, various embodiments may involve utilizing a content interpretive signature. The term content interpretive may be understood to include signatures that are representative of at least some content attribute of primary data. With reference to examples described elsewhere herein, such content may include for example speech content, picture content, and the like, but need not be limited to these examples and indeed a content interpretive signature may represent any content capable of being represented in signature form. Additionally, embodiments may involve using a baseline signature, which may be understood to include signatures that represent information that has been established as a baseline to which other information may be related. For example, in some embodiments a baseline signature perhaps may be a baseline phoneme, which may be a standardized phoneme selected perhaps for comparison to other phonemes for phoneme classification purposes.

It also may be appreciated that signatures may be generated in any suitable manner appropriate for a given application. For example, some embodiments may involve generating signatures in real time, which may be understood to include generating a signature at or substantially close to the time at which primary data content is generated to which the signature ultimately may be related. Similarly, embodiments may involve generating signatures in post time, which may include generating a signature after primary data content has already been generated and perhaps fixed in a substantially permanent form. Further embodiments may involve generating digital signature output directly from user speech input. The term directly may be understood to include only steps required to directly convert such user speech to digital signature content, perhaps eliminating intermediate steps such as intermediate steps that may involve converting the user speech to text and then generating phonemes from such text on merely an output basis. It may be appreciated that such a step of generating digital signature output directly from user speech input may be effected by a digital output generator (38) responsive to a signature manipulation system (35), as may be shown for some embodiments conceptually in FIGS. 1-7, perhaps including signature manipulation systems (35) as described elsewhere herein.

Various embodiments also may involve defining a signature from user generated input, or perhaps even automatically generating a signature. The term automatic may be understood to include generating a signature substantially without human intervention, for example as perhaps may be performed by an automated machine or programmed computer. Moreover, certain embodiments may involve automatically generating a signature from primary data content, which simply may involve directly using attributes of primary content to generate the signature. However, embodiments also may include automatically generating a signature from secondary data content, which may involve using attributes of secondary content to generate a signature that may not be directly related to the primary content itself. Of course, with respect to all embodiments of generating a signature, the signature may be placed within a secondary data structure. Moreover, in various embodiments such placement may be accomplished by a secondary placement processor (39), as may be shown for some embodiments conceptually in relation to a signature manipulation system (35) in FIGS. 1-7. In a voice mail message context, for example, an automatically generated signature perhaps may include generating associated telephone number or address information when the occurrence of a certain name within recorded speech content is detected. Similarly, data mining of video footage may include detecting a particular scene or event and automatically generating signatures that locate and describe similar scenes or events previously detected that appear elsewhere within the video footage.

Now with further reference to FIGS. 1-7, various embodiments may involve utilizing a byte order. The term byte order may be understood as described elsewhere herein, and may for example include utilizing a word order, coordinating a byte order to meaningful information of a primary sequenced audio-optical data content (7), creating a byte order from user generated input, and automatically generating a byte order. Moreover, it may be appreciated that byte orders may be utilized by byte order manipulation systems (36), as may be shown for some embodiments conceptually by the dotted lines in FIGS. 1-7. Such byte order manipulation systems (36) may be understood to include any components capable of utilizing byte orders in their functionality, and in various embodiments may include byte order manipulation systems (36) as described elsewhere herein. In a voice mail message context, for example, a byte order manipulation system may include a cell phone and the requisite hardware and software required to process speech information in recorded voice mails as byte orders. Similarly, in the data mining of video footage, a byte order manipulation system may be the requisite hardware and software required to manipulate video frames and sequences as byte orders.

Some embodiments may involve locating a byte location of a byte order within primary sequenced audio-optical data content (7) and storing the byte location within secondary sequenced audio-optical data content (8), as may be shown for some embodiments by the rectangles in FIGS. 1-7. The term locating may be understood to include any suitable manner by which a desired byte order may be distinguished from other byte orders, including perhaps as may be described elsewhere herein. Similarly, the term storing may be understood to include maintaining information embodying the byte location in a stable form such that it may be utilized in subsequent data processing, again perhaps as may be described elsewhere herein. Moreover, it may be appreciated that the steps of locating and storing may be effected with respect to any appropriate information that may be embodied in bytes. For example, in various embodiments a byte location may be a byte location of a signature, a phoneme, or other desired information embodied in primary data content. Moreover, embodiments also may include retrieving a byte location for a byte order stored within secondary audio-optical data content (6) and locating the byte order within primary sequenced audio-optical data content (7) by using the retrieved byte location. Additionally, it may be appreciated that the step of locating a byte location may be effected by a primary byte order location processor (40), the step of storing the byte location may be effected by a secondary byte order storage processor (41), and the step of retrieving a byte location may be effected by a secondary byte order location retrieval processor (42), as each may be shown for some embodiments conceptually in FIGS. 1-7 in relation to a byte order manipulation system (36).

Embodiments also may include relating a byte order of primary sequenced audio-optical data content (7) to secondary sequenced audio-optical data content (8). The term relating may be understood to include creating a functional relationship between the primary byte order and the secondary data content such that an action taken with respect to the secondary data content may generate an effect with respect to the primary byte order. In some embodiments, for example, the secondary data content may simply describe a byte location of the byte order within the primary sequenced audio-optical data content (7), so that the secondary data content may be used to locate the primary byte order. Of course, this example merely illustrates one possible relationship, and it may be appreciated that the step of relating may involve developing any number of relationships. For example, in various embodiments the step of relating may involve directly relating, algorithmically relating, hierarchically relating, conceptually relating, structurally relating, relating based on content, and relating based on format. Moreover, it may be appreciated that the step of relating a byte order may be effected by a relational byte order processor (43), as may be shown for some embodiments conceptually in FIGS. 1-7 in relation to a byte order manipulation system (36).

In addition, certain embodiments may include comparing at least one attribute of a byte order in primary sequenced audio-optical data content (7) to at least one attribute of a byte order in secondary sequenced audio-optical data content (8). It may be appreciated that such an attribute may be any suitable attribute for a given application which may be embodied in a byte order. Examples of such attributes may include signature information, phoneme information, information about the substance of all or a portion of the primary data content, location information for all or portions of the primary content, and the like. In this manner, it may be seen how secondary data content may be utilized to provide functionality with respect to primary data content, in as much as comparing attributes of the two may yield information that may be used in further applications. Moreover, it may be appreciated that the step of comparing may be effected by a byte order comparator (17), as may be shown for some embodiments conceptually in FIGS. 1-7 in relation to a byte order manipulation system (36).

Moreover, the step of comparing may be effected on any suitable basis, perhaps including as may be described elsewhere herein. For example, the step of comparing in various embodiments may include directly comparing, algorithmically comparing, hierarchically comparing, conceptually comparing, structurally comparing, comparing based on content, and comparing based on format. In certain embodiments the step of comparing may involve comparing at a rate faster than a playback rate of the primary sequenced audio-optical data content (7), efficiently utilizing the processing speed of a computing device used to accomplish said step of comparing, or sequentially comparing a byte order of the primary sequenced audio-optical data content (7) to a byte order of the secondary sequenced audio-optical data content (8), perhaps as may be elsewhere described herein.

Now with further reference to FIGS. 1-7, various embodiments may include utilizing a phoneme. In various embodiments, a phoneme may be a constituent phoneme of speech, and perhaps may be processed as described elsewhere herein. Moreover, it may be appreciated that phonemes may be utilized by phoneme manipulation systems (37), as may be shown for some embodiments conceptually in FIGS. 1-7 by the dotted lines. Such phoneme manipulation systems (37) may be understood to include any components capable of utilizing phonemes in their functionality, and in various embodiments may include phoneme manipulation systems (37) as described elsewhere herein. In a voice mail message context, for example, a phoneme manipulation system may include a cell phone and the requisite hardware and software required to process speech information in recorded voice mails as phonemes. Similarly, in the data mining of video footage, a phoneme manipulation system may be the requisite hardware and software required to manipulate speech content of video as phonemes.

Some embodiments may involve locating a location of a phoneme within primary sequenced audio-optical data content (7) and storing the location within secondary sequenced audio-optical data content (8). The term locating may be understood to include any suitable manner by which a phoneme may be distinguished from other phonemes, including perhaps as may be described elsewhere herein. Similarly, the term storing may be understood to include maintaining information embodying the phoneme in a stable form such that it may be utilized in subsequent data processing, again perhaps as may be described elsewhere herein. Moreover, it may be appreciated that the steps of locating and storing may be effected with respect to any appropriate data that may embody a phoneme. For example, in various embodiments a phoneme may be embodied by the phoneme itself, a corresponding baseline phoneme, a signature, or perhaps even a byte order. Moreover, embodiments also may include retrieving a location for a phoneme stored within secondary audio-optical data content (6) and locating the phoneme within primary sequenced audio-optical data content (7) by using the retrieved location information. Additionally, it may be appreciated that the step of locating a location of a phoneme may be effected by a primary phoneme location processor (44), the step of storing the location may be effected by a secondary phoneme storage processor (45), and the step of retrieving a location for the phoneme may be effected by a secondary phoneme location retrieval processor (46), as each may be shown for some embodiments conceptually in FIGS. 1-7 in relation to a phoneme manipulation system (37).

Embodiments also may include relating a phoneme in primary sequenced audio-optical data content (7) to secondary sequenced audio-optical data content (8). The term relating may be understood to include creating a functional relationship between the primary phoneme and the secondary data content such that an action taken with respect to the secondary data content may generate an effect with respect to the primary phoneme. In some embodiments, for example, the secondary data content may simply describe a location of the phoneme within the primary data content, perhaps such as a byte order location, so that the secondary data content may be used to locate the phoneme within the primary data content. Of course, this example merely illustrates one possible relationship, and it may be appreciated that the step of relating may involve developing any number of relationships. For example, in various embodiments the step of relating may involve directly relating, algorithmically relating, hierarchically relating, conceptually relating, structurally relating, relating based on content, and relating based on format. Moreover, it may be appreciated that the step of relating a phoneme may be effected by a relational phoneme processor (47), as each may be shown for some embodiments conceptually in FIGS. 1-7 in relation to a phoneme manipulation system (37).

In addition, certain embodiments may include comparing at least one attribute of a phoneme in primary sequenced audio-optical data content (7) to at least one attribute of a phoneme in secondary sequenced audio-optical data content (8). It may be appreciated that such an attribute may be any suitable attribute for a given application which may be attributed to a phoneme. Examples of such attributes may include signature information, byte order information, speech information, content information, location information, and the like. In this manner, it may be seen how secondary data content may be utilized to provide functionality with respect to primary data content, in as much as comparing attributes of the two may yield information that may be used in further applications. It also may be appreciated that the step of comparing may be effected on any suitable basis, perhaps including as may be described elsewhere herein. For example, the step of comparing in various embodiments may include directly comparing, algorithmically comparing, hierarchically comparing, conceptually comparing, structurally comparing, comparing based on content, and comparing based on format. Moreover, it may be appreciated that the step of comparing may be effected by a phoneme comparator (48), as may be shown for some embodiments conceptually in FIGS. 1-7 in relation to a phoneme manipulation system (37). In a voice mail context, for example, a signature in an attached header file may describe phoneme information corresponding to a word or phrase, and a phoneme comparator may use the signature information to search the voice mail message for the occurrence of the word or phrase.

In some embodiments, the step of comparing may involve comparing a phoneme order. The term phoneme order may be understood to include two or more phonemes arranged in a particular order. It may be appreciated that such an order may perhaps carry an associated information meaning, for example perhaps as when phonemes are ordered into words, phrases, sentences, or the like. In some embodiments, comparing a phoneme order may involve sequentially comparing a phoneme order in primary sequenced audio-optical data content (7) to a phoneme order of secondary sequenced audio-optical data content (8). Moreover, in some embodiments comparing a phoneme order may involve creating a phoneme representation. The term phoneme representation may be understood to include data representing a phoneme having a sufficiently close identity to the represented phoneme such that the same criteria used to identify the phoneme representation will also serve to identify the phoneme itself. Moreover, in various embodiments the step of creating a phoneme representation may involve utilizing a user generated phoneme representation, automatically generating a phoneme representation, or perhaps even utilizing a baseline phoneme.

In various embodiments, the step of comparing may involve comparing at least one attribute of a phoneme in primary sequenced audio-optical data content (7) to at least one attribute of a baseline phoneme in secondary sequenced audio-optical data content (8). The term baseline phoneme may be understood perhaps as defined elsewhere herein. Moreover, a baseline phoneme in various embodiments may be selected from a grammar set. The term grammar set may be understood to encompass sets of predefined phonemes that have been associated into units having grammatical meaning. For example, grammar sets may include sets of associated phonemes corresponding to words, names, places, colloquial phrases, slang, quotations, and the like. Such associated phonemes may be termed baseline phoneme grammars.

In this manner it may be seen that using baseline phoneme grammars in a secondary data structure may enhance the utility of the secondary data structure. In particular, embodiments that utilize baseline phoneme grammars may accomplish the step of comparing with a high degree of efficiency, in as much as the baseline phoneme grammars may tend to efficiently correlate to the native grammatical arrangement of phonemes in primary data content. Moreover, certain embodiments may utilize baseline phoneme grammars to even higher degrees of efficiency.

For example, grammar sets in various embodiments may be further refined into content targeted predefined vocabulary lists. Such content targeted predefined vocabulary lists may be understood to encompass grammar sets having baseline phoneme grammars targeted to specialized vocabulary, for example industry specific content, foreign language content, content utilizing specialized jargon, and the like. Accordingly, the use of content targeted predefined vocabulary lists may simplify the step of comparing by providing targeted baseline phoneme grammars that may tend to efficiently correlate to the native grammatical arrangement of phonemes in primary data content that otherwise might present difficult vocabularies to compare.

Embodiments also may include using a tree format organized grammar set. The term tree format organized may be understood to include grammar sets having baseline phoneme grammars organized into two or more tiers, perhaps including tiers arranged into a tree format. With reference to the step of comparing, such tiers may provide multiple comparison opportunities, with each tier providing a basis for comparison. Such an arrangement of tiers perhaps may increase the efficiency with which the step of comparing may be accomplished. For example, using a tree format organized grammar set in some embodiments may involve comparing high possibility grammars first, then using subsets of individual grammars for specific phoneme recognition. Such a tiered system may reduce unnecessary comparison steps by first narrowing the field of possible matches in the high possibility tier, and only testing for specific matches in the specific phoneme recognition tier. For example, when a specific word or phrase is sought to be located within a voice mail message, the voice mail message may be quickly scanned at a first tier level only to determine portions of the speech in which occurrence of the word or phrase is highly probable, and then only those selected portions may be further tested to determine if the word or phrase actually appears.

Now with further reference to FIGS. 1-7, various embodiments may include storing primary sequenced audio-optical data content (7) in a non-interpreted manner and providing functionality to the stored primary sequenced audio-optical data content (7) via a secondary sequenced audio-optical data structure (4). The term storing may be understood to include maintaining the primary sequenced audio-optical data content (7) in a stable form such that it may be utilized in subsequent data processing. In some embodiments, the term storing may include primary data content stored in computer memory. The term non-interpreted manner may be understood to include a manner in which the primary data content has not been substantially altered through data processing, including perhaps storing the primary data content in substantially its original format. The term functionality may be understood to include the ability to take an action with respect to a secondary data structure and effect a result with respect to stored primary data content. Moreover, it may be appreciated that the steps of storing primary sequenced audio-optical data content (7) and providing functionality may be effected respectively by a primary content storage processor (49) and a secondary content functionality processor (50), as may be shown for some embodiments conceptually in FIGS. 1-7 in relation to a phoneme manipulation system (37).

In some embodiments, the step of providing functionality may include closing the primary sequenced audio-optical data content (7), searching the secondary sequenced audio-optical data content (8), selecting a location of a desired data element within the primary sequenced audio-optical data content (7) by accessing that location stored within the secondary sequenced audio-optical data content (8), opening the primary sequenced audio-optical data content (7), and retrieving only the desired data element. The term closing may be understood to include changing a readiness state of data content to a substantially unavailable state, and the term opening may be understood to include changing a readiness state of data content to a substantially ready state. Accordingly, it may be appreciated from the foregoing that a data element within primary data content may be identified, searched for, and retrieved by utilizing only secondary data content, with the exception only of opening the primary data content to retrieve the desired data element. Moreover, it also may be appreciated that the desired data element may be retrieved with specificity, that is to say, without reference to or the use of surrounding data content. Moreover, it may be seen that the steps of closing, searching, selecting, opening, and retrieving may be accomplished by a data content closure processor, a data content search processor, a data content selection processor, a data content open processor, and a data content retrieval processor, respectively. In the data mining of video footage, for example, a search for the occurrence of a particular scene or event may be made using only a previously populated header. In particular, the occurrence of the scene or event may be determined simply by scanning data stored in the header, and the video footage itself may require opening only to retrieve the desired scene or event once its location has been determined.

Additionally, in certain embodiments, the step of providing functionality may involve utilizing secondary sequenced audio-optical data content (8) to locate a desired snippet of primary sequenced audio-optical data content (7) and manipulating only the desired snippet of the primary sequenced audio-optical data content (7). The term snippet may be understood to include only a desired portion of primary data content, irrespective of the form or content of surrounding data content. In this manner, it may be appreciated that the secondary data content may be used to effect the manipulation only of desired portions of primary data content, irrespective of the qualities or attributes of the greater primary data content in which the portion resides. Moreover, it may be appreciated that the steps of utilizing secondary sequenced audio-optical data content (8) and manipulating only a desired snippet may be accomplished by a snippet location processor and a snippet playback processor, respectively. In a voice mail message context, for example, the occurrence of a name or location may be determined within a voice mail message perhaps simply from using information in an attached header, without reviewing the voice mail message itself. Moreover, the name or location may then be retrieved without accessing any other information of the voice mail message, for example perhaps simply by retrieving only the byte order corresponding to the portion of the voice mail message at which the name or location occurs.

Now with further reference to FIGS. 1-7, various embodiments may include establishing a concatenated primary sequenced audio-optical data structure (3). The term concatenated may be understood to include multiple primary data structures linked together without substantial subdivision of primary data content located therein. In some embodiments, such concatenated primary data structures perhaps may be achieved using variable memory unit formats (26). It also may be appreciated that a concatenated primary data structure may be concatenated from multiple disparate primary data content, and perhaps may be concatenated on the fly in real time as primary data content is generated.

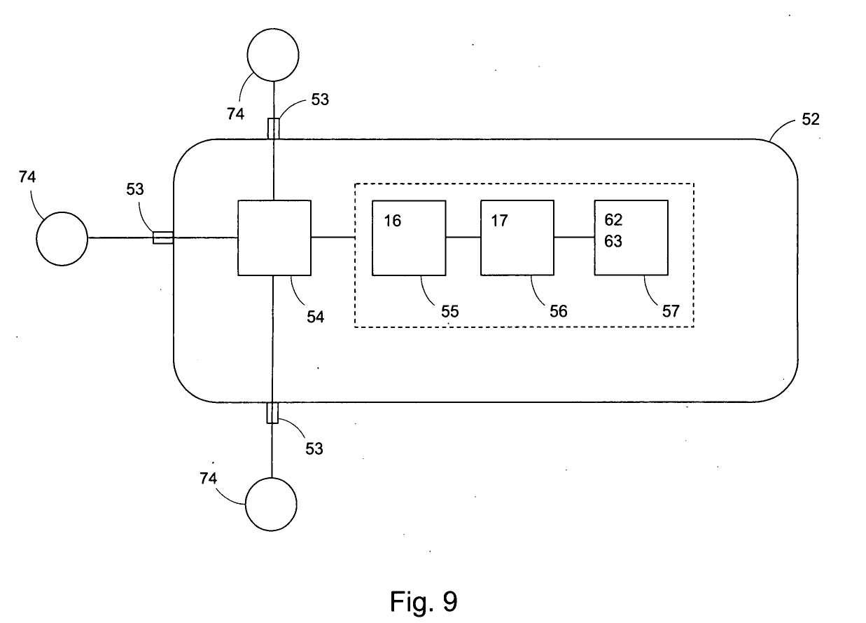

Now with reference to FIGS. 9-12, various embodiments may involve an exchange of conferenced electronic communications. Conferencing may allow multiple participants at remote locations to communicate with one another via audio, video, or other kinds of data feeds transmitted over a communications network, such as the publicly switched telephone network, the Internet, or other suitable networks. Typically, the audio, video, or other data feeds from individual participants may be received by a conferencing device incorporating specialized hardware or software. Such conferencing devices may allow the audio, video, or data feeds from each participant to the conference to be made available to all other participants to the conference via the communications network. In this manner, the participants to the conference may communicate with each other, and data transferred via the conferencing device may be termed conferenced data.

Conferenced data may include any electronic data capable of being transmitted in a conferenced manner, for example such as speech data, verbal data, voice data, phoneme data, text data, image data, visual data, audio data, video data, analog data, digital data, object code data, source code data, telephony data, ANI data, metadata, time data, date data, agenda data, exhibit data, conference participant data, topic data, word data, sentence data, caption data, file type data, contextual indicia data, and any combination thereof. In some embodiments, populating a primary sequenced audio-optical data structure (3) with primary sequenced audio-optical data content (7) may involve populating the structure with conferenced data.

Individuals, entities, or other such participants to an exchange of conferenced electronic communications (73) may have an electronic identity characteristic. Such a characteristic may provide electronic data tending to identify the participant in an exchange of conferenced electronic communications, and for example may be included with or form part of a conferenced electronic communication sent by the participant. Any suitable identifying characteristic capable of being embodied in electronic data may be used as an electronic identity characteristic, such as voice information, image information, ANI information, or the like. In some embodiments, an electronic identity characteristic may be or be based on unique personal data. This may be information uniquely personal to an individual, such as an individual's vocal characteristics, an individual's facial features, or the like.

Examples of individuals, entities, or other such participants to an exchange of conferenced electronic communications (73) may include prospective conference participants (74) (such as individuals, entities, or the like not yet participating in an exchange of conferenced electronic communications) and conference participants (74) (such as individuals, entities, or the like already joined to an exchange of conferenced electronic communications). Of course, an electronic identity characteristic may be obtained from any identifying electronic data of an individual or entity, even outside of an exchange of conferenced electronic communications, such as perhaps taken for future use from individuals having known or unknown identities.

Various embodiments may involve automatically capturing an electronic identity characteristic and automatically analyzing the captured electronic identity characteristic. Capture may involve receiving the electronic identity characteristic into an automated device and making it available for processing by the device, such as perhaps where an electronic communication having an electronic identity characteristic may be received as electronic data into a computer memory and made available to a computer processor, subroutine, or the like. In some embodiments, capture may be effected by an automated electronic identity characteristic capture subroutine (55), such as part of an automated conference participant detector (54), part of an automated conferenced electronic communications initiation control (59), responsive to an electronic identity signature memory (70), or the like. Of course, an automated electronic identity characteristic capture subroutine (55) in various embodiments may be an automated conference participant electronic identity characteristic capture subroutine, an automated prospective conference participant electronic identity characteristic capture subroutine, a unique personal data capture subroutine, or the like. Naturally, analysis may involve any suitable processing of the electronic identity characteristic by the automated device to achieve a specified analytical result, such as verifying the identity of a conference participant, selectively granting or denying access of a participant to a conference, verifying the identify of a known or unknown individual, and the like. In some embodiments, analysis may be effected by an automated electronic identity characteristic analysis processor (56) responsive to an automated electronic identity characteristic capture subroutine (55).

For example, in some embodiments, automatically capturing an electronic identity characteristic may involve creating a byte order representation of the electronic identity characteristic, perhaps as discussed elsewhere herein, and an automated conference participant electronic identity characteristic capture subroutine (55) in various embodiments may be a byte order representation generator (16). Similarly, automatically analyzing an electronic identity characteristic may involve comparing the byte order representation of the electronic identity characteristic to a known byte order arrangement, perhaps as discussed elsewhere herein, and an automated conference participant electronic identity characteristic analysis processor (56) may be a byte order comparator (17). The known byte order arrangement can be for data representing any known quantity against which the byte order representation is to be analyzed, such as a known voice, a known image, a known ANI, or the like.

In this manner, the degree of congruence or divergence of the electronic identity characteristic from the known quantity can be evaluated based on comparison of their byte orders. Various embodiments even may employ a deviation threshold upon which an analytical conclusion can be based. The deviation threshold may represent the limit of acceptable versus unacceptable deviations between byte orders of the electronic identity characteristic and the known quantity for purposes of determining if they are the same or different—if the deviations exceed the threshold, the electronic identity characteristic may be dissimilar enough to the known quantity to conclude that they are different, and if the deviations fall within the threshold, the electronic identity characteristic may be similar enough to conclude they are the same. Of course, the deviation threshold may be adjusted to raise or lower the degree of permissible deviation, for example such as to increase or decrease the confidence level of the conclusion.

Various types of analytical conclusions perhaps may be obtained by using a deviation threshold. For example, some embodiments may involve denying access of a conference participant to a conference when a byte order representation for an electronic identity characteristic of the conference participant is found to exceed a deviation threshold as compared to known byte order arrangements for authorized conference participants (74). In this manner, unauthorized “ghost listeners” or the like may be dropped from conferences. Communication with such unauthorized “ghost listeners” may be terminated, and their electronic identity characteristic may be used to block any or all further conferenced electronic communications (73) having that electronic identity characteristic. Accordingly, an automated conference participant access selection control (57) in various embodiments may be a byte order representation deviation threshold control, a communications termination control, or a captured conference participant electronic identity characteristic block.

A further example may involve verifying any or all prospective conference participants (74) before they are joined to the conference. Verification may be made for example when a byte order representation for an electronic identity characteristic of the prospective conference participant falls within a deviation threshold as compared to a known byte order arrangement for that prospective conference participant. This may be effected, for example, in various embodiments where an automated prospective conference participant identity verification processor (60) may be a byte order representation deviation threshold control (62). Again, communication may be terminated with any prospective conference participant whose identity is not successfully verified, perhaps such as with a communications termination control (63) responsive to an automated prospective conference participant identity verification processor (60).

Still another example may involve simply verifying the identity of known and unknown individuals. The byte order representation of an electronic identity characteristic captured from an unknown individual (88) may be compared to a pre-stored electronic identity signature having a known byte order arrangement for a known individual (87). Verification may be made for example when the byte order representation falls within a deviation threshold as compared to the byte order arrangement. Accordingly, an automated identity verification processor (71) in various embodiments may be a byte order representation deviation threshold control (62).

Accordingly, with reference to FIG. 9, embodiments may include a method for selectively denying access to conferenced electronic communications, such as may be effected in some embodiments by a conferenced electronic communications access apparatus (52) having a conferenced electronic communications input (53). The method may involve automatically detecting at least one conference participant to an exchange of conferenced electronic communications. Such automatic detection may be effected by any suitable hardware, software, or combination thereof, such as for example an automated conference participant detector (54) responsive to a conferenced electronic communications input (53). The method may further include automatically capturing at least one electronic identifying characteristic of the conference participant, automatically analyzing the captured electronic identity characteristic, and automatically selectively denying access to the conference participant to the exchange of conferenced electronic communications (73) based on the analysis, each such as consistent with the principles described herein. The selection in denying access may be made on any suitable criteria based on the analysis, for example such as denying access based on a deviation threshold, and in various embodiments may be effected by an automated conferenced participant access selection control (57) responsive to an automated conference participant electronic identity characteristic analysis processor (56).

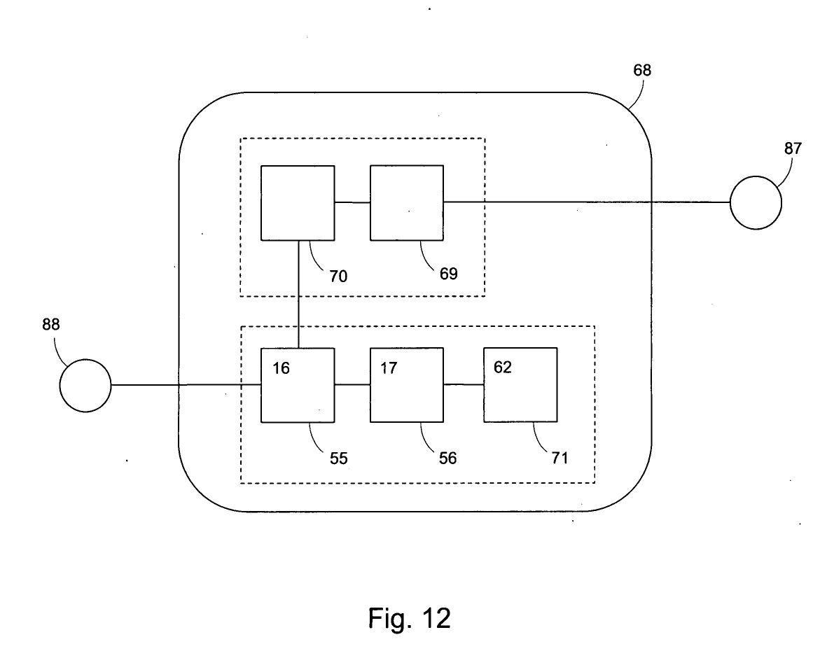

With reference to FIG. 12, embodiments also may involve a method for electronic identity verification, such as may be effected in some embodiments by an electronic identify verification apparatus (68). The method may include creating an electronic identity signature for a known individual (87) and pre-storing the electronic identity signature. The signature may represent electronic identity data for the known individual (87), perhaps providing a standard basis for identifying the known individual (87), and may be embodied in a byte order arrangement. Pre-storing the electronic identity signature may keep the signature available for uses of this type, and such creation and pre-storage may be accomplished by any suitable hardware, software, or combination thereof, such as with such as with an electronic identity signature generator (69) and an electronic identity signature memory (70). In various embodiments, an electronic identity signature may comprise speech data, verbal data, voice data, phoneme data, text data, image data, visual data, audio data, video data, analog data, digital data, object code data, source code data, telephony data, ANI data, metadata, time data, date data, agenda data, exhibit data, conference participant data, topic data, word data, sentence data, caption data, file type data, contextual indicia data, and any combination thereof. Embodiments also may include creating an electronic identity signature by capturing unique personal data, and an electronic identity signature generator (69) may be a unique personal data capture subroutine.

The method may further include automatically capturing at least one electronic identifying characteristic of an unknown individual (88) and automatically analyzing the captured electronic identifying characteristic in relation to the pre-stored electronic identity signature for said known individual (87), such as consistent with the principles described herein. Using the pre-stored electronic identity signature to analyze the captured electronic identity characteristic may yield similarities and differences between the two. In this manner, it may be possible to automatically verify the identity of the unknown individual (88) based on the analysis of the captured electronic identity characteristic, for example since the pre-stored electronic identity signature may provide a standard basis for identifying the known individual (87). Such verification in various embodiments may be accomplished with an automated identity verification processor (71) responsive to an automated electronic identity characteristic capture subroutine (55).

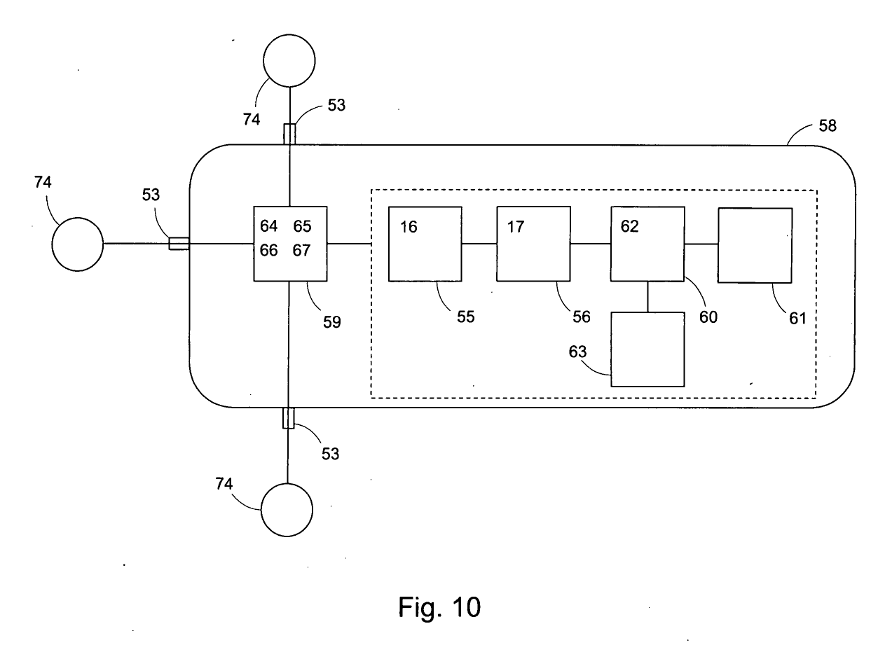

With reference to FIG. 10, embodiments may involve a method for completing an exchange of conferenced electronic communications, such as may be effected in some embodiments by a conferenced electronic communications exchange completion apparatus (58). The method may include automatically initiating conferenced electronic communications (73) among a plurality of prospective conference participants (74). Initiating conferenced electronic communications (73) should be understood to involve creating the requisite connections among the prospective conference participants (74) to enable the exchange of conferenced electronic communications (73) without actually permitting such an exchange to take place. Suitable hardware, software, or any combination thereof may be used to accomplish such initiation, such as an automated conferenced electronic communications initiation control (59). For example, embodiments may involve automatically dialing one or more prospective conference participants (74) without conferencing them into the conference. As a result, an initiated state may be created where individual prospective conference participants (74) are available to join the conference but not yet admitted to it.

Such an initiated state may allow the identity of any individual prospective conference participant to be verified before they are admitted to the conference. For example, an electronic identity characteristic may be automatically captured and analyzed for each prospective conference participant, and the identity of any or all prospective conference participants (74) may be automatically verified based on the analysis, each such as consistent with the principles described herein. In various embodiments, this may be accomplished by an automated prospective conference participant identity verification processor (60), such as responsive to an automated prospective conference participant electronic identity characteristic analysis processor (56). In this manner, the initiated conferenced electronic communications (73) may be automatically completed, for example, only among the prospective conference participants (74) whose identity has been successfully verified. Naturally, completing the initiated conferenced electronic communications (73) may involve permitting an exchange of conferenced electronic communications (73) among conference participants (74) where the requisite connection were previously established, such as by conferencing in participants who already have been dialed. An automated conferenced electronic communications completion control (61) responsive to said automated prospective conference participant identity verification processor (60) perhaps may be utilized to complete conferenced communications in various embodiments.

Moreover, conferenced electronic communications (73) may be automatically initiated on a recurring basis. This may allow conferences to take place at repeating times that can be coordinated to specific schedules, facilities, availabilities, and the like. The basis for the recurrence can be any as may be appropriate. For example, the recurring basis may be a user defined recurring basis, an automatically set recurring basis, a periodic recurring basis, a scheduled recurring basis, and the like. Accordingly, embodiments may include a recurrent automated conferenced electronic communications initiation control (64), perhaps such as a user defined recurrent control, an automated recurrent control, a periodic recurrent control, a scheduled recurrent control, or the like.

In addition, the prospective conference participants (74) with whom a conference may be automatically initiated may be predefined. This may allow conferences to take place only with participants who are necessary or appropriate for the subject matter of any given conference. The basis for predefinition can be any as may be appropriate. For example, predefining prospective conference participants (74) may involve user predefining prospective conference participants (74), automatically predefining prospective conference participants (74), adding prospective conference participants (74), removing prospective conference participants (74), using a contacts list to define prospective conference participants (74), conferencing in prospective conference participants (74) on an as-needed basis such as when input is required only for certain agenda topics, and the like. Accordingly, embodiments may include a predefined prospective conference participant contact subroutine (65), perhaps such as a user predefined prospective conference participant contact subroutine, an automatically predefined prospective conference participant contact subroutine, a prospective conference participant addition contact subroutine, a prospective conference participant removal contact subroutine, a predefined contacts list prospective conference participant contact subroutine, and a necessary basis predefined prospective conference participant contact subroutine, or the like.

In addition, where a conference has been calendared, naturally reminders to prospective conference participants (74) may be automatically sent. Embodiments accordingly may include a conference calendaring control (66) and a prospective conference participant reminder control (67).

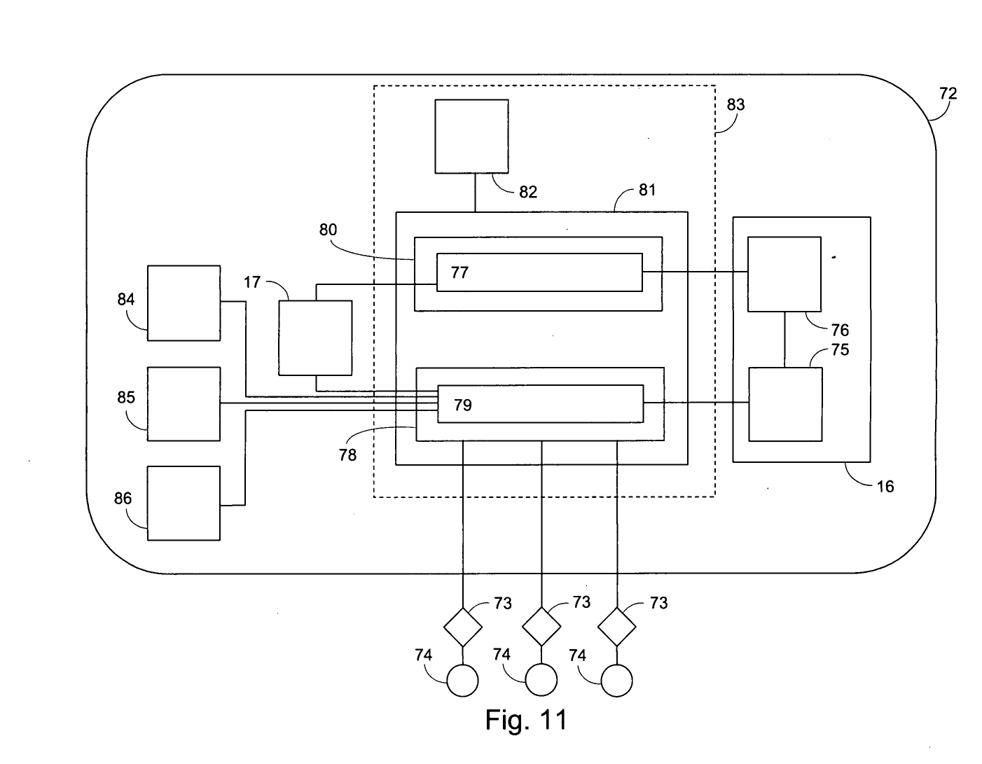

Now with reference to FIG. 11, various embodiments may involve a method for creating derivative conferenced data (77), such as effected in some embodiments by a derivative conferenced data creation apparatus (72). Conferenced electronic communications (73) may be exchanged among a plurality of conference participants (74), and at least one conferenced data element within the exchanged conferenced electronic communications (73) may be identified, for example with a desired conferenced data element identification processor (75) responsive to the exchanged conferenced electronic communications (73). A conferenced data element simply may be some subset or constituent part of conferenced data, and identification may serve to distinguish the conferenced data element so that it can be utilized separately from its surrounding content. Identification may be made by any suitable basis upon which a conferenced data element may be distinguished from its surrounding content, such as for example by time, by date, by name, by conference participant, by agenda item, by conference exhibit, by file type, by electronic identity characteristic, or by any other like property of the element, and a desired conferenced data element identification processor (75) may be configured to identify a conferenced data element on any such basis.

Some embodiments may involve identifying changed conferenced data. Changed conferenced data may be conferenced data that is transformed, modified, or otherwise altered during an exchange of electronic communications. For example, participants to a conference may change participant information (such as by adding or removing participants for current or future conferences), agenda information (such as by adding, removing, or modifying agenda items), exhibit information (such as by adding, removing, or modifying information in an exhibit), and the like, although any information embodied as conferenced data and exchanged as conferenced electronic communications (73) may be changed. Changes may also be made in real time or near-real time during a conference, such as on-the-fly while the information is being utilized, or in post processing, such as where a conference participant may return to the conferenced data and make changes after the fact. Any such changes may be identified as changed conferenced data, and in various embodiments a conferenced data element identification processor (75) may be a changed conferenced data identification processor (75).

Moreover, identification may be done manually, as where a user may exercise judgment to select a conferenced data element for identification, or identification may done automatically, as wherein suitable hardware, software, or the like may be provided with parameters, algorithms, or the like to select a conferenced data element for identification. Accordingly, a desired conferenced data element identification processor (75) in various embodiments may be a manual desired conferenced data element identification processor, an automatic desired conferenced data element identification processor, or the like.

Embodiments may involve associating a conferenced data tag to an identified conferenced data element. The tag may embody information about the identified conferenced data element, such as for example its location within the conferenced data, the information content of the conferenced data element, or the like, though of course any attribute of the conferenced data element capable of being embodied by the tag may be utilized. Associating the tag to the conferenced data element may involve defining the relationship between the two, such as the relation between the specific data content element with which the tag is associated and the information about the data content element embodied in the tag. Any suitable hardware, software, or combination thereof may be utilized to associate a conferenced data tag to an identified conferenced data elements, such as in various embodiments a desired conferenced data tag association processor (76) responsive to a desired conferenced data element identification processor (75).

Analogous to the identification of a conferenced data element, the association of a conferenced data tag to an identified conferenced data element may be done manually, as where a user may exercise judgment to create the association, or automatically, as where the association may be made via parameters, algorithms, or the like provided to suitable hardware, software, or combinations thereof. Accordingly, a conferenced data tag association processor (76) in various embodiments may be a manual conferenced data tag association processor or an automatic conferenced data tag association processor. Moreover, manual association may be done in any manner amenable to manual manipulation, such as associating by manual data entry (as through the use of keystrokes, mouse clicks, digital pens, or the like), associating by voice (as through the use of speech recognition software of the like), associating by silent tagging (as through the use of silent DTMF in telephony or the like), or any other suitable manual method. Similarly, automatic association may be done in any manner amenable to automation. Both manually and automatically associating a conferenced data tag to an identified conferenced data element may be done in real time (as wherein the association created at the same time as the conferenced data element is created), near real time (as wherein the delay in creating the association does not affect any use to which the conferenced data element, the conferenced data tag, or any derivative conferenced data may be put), or in post processing (as wherein generation of the conferenced data within which the conferenced data element is completed, and the association is created after the fact). Naturally, manual and automatic conferenced data tag association processors may be configured for any suitable manner of manual manipulation or automation, such as perhaps those just described.

In various embodiments, associating a conferenced data tag to an identified conferenced data element may create derivative conferenced data (77), for example as wherein the derivative conferenced data (77) may be responsive to a conferenced data tag association processor (76). Such derivative conferenced data (77) may include the conferenced data tag and the conferenced data element with which the tag is associated, and the information embodied in the two may be seen as derived from the original, untagged conferenced data element. Of course, derivative conferenced data (77) may not be limited to just the tag and the data element—the tag and data element may form part of a larger data structure or relationship among conferenced data, perhaps involving other derivative conferenced data (77), for example as wherein the tag and data element may be utilized as part of primary conferenced data structures and secondary conferenced data structures.

Moreover, various kinds of augmented functionalities may be derived for said conferenced data element by associating it to a conferenced data tag. Such augmented functionalities may involve creating useful applications for the conferenced data element that are possible only through the augmented data derived from the associated conferenced data tag. While some examples of such augmented functionalities may be described herein, it should be understood that any such useful applications made possible by the associated conferenced data tag may form the basis for an augmented functionality.

Now referring primarily to FIG. 11, the principles of primary data structures, secondary data structures, and byte-based techniques discussed elsewhere herein may be applied to conferenced data in various embodiments. For example, various embodiments may involve establishing a primary conferenced data structure (78), populating the primary conferenced data structure (78) with primary conferenced data content (79), and arranging the primary conferenced data content (79) in a byte order. This may be effected perhaps as described elsewhere herein. Similarly, identifying a conferenced data element and associating a conferenced data tag to the identified conferenced data element in various embodiments may involve creating a byte order representation of the desired conferenced data element, again perhaps as described elsewhere herein. Accordingly, a conferenced data element identification processor (75) and a conferenced data tag association processor (76) in various embodiments may include a byte order representation generator (16).

Moreover, creating derivative conferenced data (77) may involve relating the byte order representation of the desired conferenced data element to the byte order arrangement of the primary conferenced data content (79). In this manner, the derivative conferenced data (77) may include data describing a relationship between the desired conferenced data element and the primary conferenced data content (79) from which the element was derived. Any relationship that may be derived from the relative byte orders of the desired conferenced data element and the primary conferenced data content (79) may be related in this manner and expressed in the derivative conferenced data (77). For example, the relationship may describe location (such as wherein the derivative conferenced data (77) describes the location of the conferenced data element within the primary conferenced data content (79)), information content (such as what information in the primary conferenced data content (79) the conferenced data element describes), or any other relationship between the primary conferenced data content (79) and the conferenced data element capable of being derived from their byte orders. In this manner, derivative conferenced data (77) in various embodiments may include a byte order representation of a conferenced data element responsive to a byte order representation generator (16).

One example of relating a byte order representation of a desired conferenced data element to a byte order arrangement of primary conferenced data content (79) may involve comparing the byte order representation to the byte order arrangement, again perhaps as described elsewhere herein. Accordingly, embodiments may include a byte order comparator (17) to which a byte order representation of a conferenced data element and a byte order arrangement of primary conferenced data content (79) are responsive.

Other examples of relating a byte order representation of a desired conferenced data element to a byte order arrangement of primary conferenced data content (79) may involve data mining primary conferenced data, post processing primary conferenced data, or perhaps even post process data mining primary conferenced data. Data mining may involve identifying subcontent, locating subcontent within the conferenced data, demarcating subcontent from other content in the conferenced data, and the like. Byte locations of subcontent within the byte order of the conferenced data may be determined, and the structure of the subcontent may be preserved for future processing. Subcontent may include any constituent part of the conferenced data, such as sentences, captions, phrases, words, phonemes, ANIs, file types, or the like. For example, conferenced data may be mined for occurrences of a particular word or phrase, input from a specific participant, or the like. Speech recognition software may be used where appropriate to convert between speech and text. Post processing primary conferenced data content (79) may involve processing the data content after generation of the conferenced data is completed, as for example after a conference has ended. Naturally, post process data mining may involve data mining primary conferenced data content (79) after generation of the conferenced data is completed. Of course, the data mining and post processing described herein may be accomplished by any suitable hardware, software, or combination thereof, such as in various embodiments by a primary conferenced data content data mining processor (84), a primary conferenced data content post processor (85), a primary conferenced data content data mining post processor (86), or the like.

Various embodiments may involve establishing a secondary conferenced data structure (80) and populating the secondary conferenced data structure (80) with derivative conferenced data (77), perhaps as described elsewhere herein. Embodiments further may involve storing the primary conferenced data structure (78) and the secondary conferenced data structure (80). Any suitable hardware, software, or combination thereof capable of maintaining the primary conferenced data structure (78) and the secondary conferenced data structure (80) may be utilized for such storage. For example, embodiments may utilize an electronic memory (81) in which the primary conferenced data structure (78) and the secondary conferenced data structure (80) may be stored.

In addition, embodiments may involve accessing a desired conferenced data element within a primary conferenced data structure (78) utilizing the derivative conferenced data (77) of the secondary conferenced data structure (80). In such embodiments, the derivative conferenced data (77) may embody a relationship with the desired conferenced data element enabling such access, such as perhaps as previously described. For example, the derivative conferenced data (77) may specify the location of the desired conferenced data element within the primary conferenced data structure (78), though of course any relationship enabling access of the desired conferenced data element may be embodied by the derivative conferenced data (77). Access to the desired conferenced data element in this manner may make the desired conferenced data element available for use, for example in any application by which the desired conferenced data element may be utilized. Access in the manner described may be implemented by any suitable hardware, software, or combination thereof, for example in certain embodiments by a desired conferenced data element access processor (82).

Moreover, such storing of primary and secondary conferenced data structures, the creation of access as described, or the combination thereof may create a database (83) of primary conferenced data and secondary conferenced data enabling the application of the data content to a variety of uses. As but some examples, accessing a desired conferenced data element in various embodiments may include retrieving the desired conferenced data element, retrieving the desired conferenced data element in situ, retrieving the desired conferenced data element separate from surrounding content, sorting the desired conferenced data element, delivering the desired conferenced data element to a communications device such as a telephone or a computer, delivering the desired conferenced data element to a media output device such as a printer or compact disc, or the like. Of course, these examples are merely illustrative and are not intended to limit the scope of the inventive principles set forth. Naturally, a desired conferenced data element access processor (82) may include one or more subroutines to accomplish any use of primary conferenced data and secondary conferenced data in a database consistent with the principles described herein, such as for the examples set forth above.

Throughout the description set forth herein, various embodiments may involve performing certain actions automatically. By the term automatic, an action may be understood to be performed substantially without human intervention, for example as perhaps may be performed by an automated machine or programmed computer. In addition, various elements may be described as responsively related, that is, some effect in one may directly or indirectly cause an effect or change in another.

Now with further reference to all of the drawing figures, embodiments may involve implementing any of the actions discussed herein in various types of environments or network architectures. For example, network architectures in some embodiments may include one or more components of a computer network, and relevant environments may include peer-to-peer environments or client-server environments. Moreover, implementation may be made according to the particular configuration of a network architecture or environment. In a client-server environment, for example, implementation may occur at a server location, at a client location, or perhaps even at both servers and clients. Of course, a client may be any suitable hardware or software capable of serving in a client-server fashion. In some embodiments, for example, a client may be a computer terminal, a cell phone, or perhaps even simply software residing on a computer terminal or cell phone. These examples are merely illustrative, of course, and should not be construed to limit the hardware or software which may serve as a suitable client.

Additionally, it may be appreciated that the various apparatus discussed herein may themselves be arranged to form all or parts of a network architecture or environment, or perhaps may be configured to operate in association with a network architecture or environment. Moreover, communication among the apparatus of such networks or environments may be accomplished by any suitable protocol, for example such as hypertext transfer protocol (HTTP), file transfer protocol (FTP), voice over internet protocol (VOIP), or session initiation protocol (SIP). For example, embodiments may include a cell phone acting as a client on a network with a server via VOIP, perhaps even wherein the cell phone itself utilizes SIP in conjunction with the VOIP. Of course, the foregoing merely is one example of how hardware, software, and protocols may interact on a network, and any suitable environment meeting the requirements as discussed herein may be utilized.

Now with further reference to all of the drawing figures, in various embodiments described herein, some actions may be described as relating one element to another element. The term relating may be understood simply as creating a relationship between such elements described. The nature of the relationship may be understood as further described with respect to the particular elements described or as may be appreciated by one skilled in the art. Stated differently, two elements that have been related may enjoy some degree of association that stands in distinction from two elements that share no degree of association. Moreover, it may be understood that an action described as relating one element to another may be implemented by an apparatus, and that such an apparatus may be described as being relational, even if the relation is indirect or occurs through intermediate elements or processes.

Moreover, some actions may described in terms of a certain modality in which the action is undertaken. For example, some actions may be performed in situ, in which the action may be understood to be performed on an object left in place relative to its surrounding matter, while other actions may be performed such that their undertaking separates the object receiving the action from its surrounding content. Certain actions may be performed independently from a time indexed basis, in which the execution of the action may not rely on runtime information of the object receiving the action. Similarly, certain actions may be performed independently of a text indexed basis, in which execution of the action may not rely on text information of the object receiving the action.

Additionally, some actions may be described with reference to the manner in which the action is performed. For example, an action may be performed on a content basis, wherein performance of the action may require content information about the object of the action in order to be carried out. An action may also be structurally performed, in which performance of the action may require structural information about the object of the action in order to be carried out. In some cases, an action may be directly performed, wherein performance of the action may directly affect the object of the action without any intermediary steps. Conversely, an action may be algorithmically performed, wherein the action may undergo some degree of algorithmic transformation through at least one step before the action is applied to its object. Of course, the term algorithmic may be understood to encompass any of a wide number of suitable manipulations, especially as may be used in data processing, and in various embodiments may include actions such as a weighted analysis, a best fit analysis, a comparison to multiple values, a criterion threshold test, fuzzy logic, and the like. Actions may also be performed on an information meaning basis, in which performance of the action may require information about a user interpretable meaning of the object on which the action is to be performed. Moreover, actions may be performed on a format basis, wherein performance of the action may require format information about the object of the action in order to be carried out. Actions further may be performed on a selective basis, which may include simply applying some degree of selective criteria to govern the circumstances under which the action is effected. Some actions may be hierarchically performed, in which performance of the action may depend on a hierarchical arrangement of the object of the action. Actions also may be performed on a conceptual basis, in which performance of the action may depend on conceptual content of the object receiving the action, for example as opposed to merely format or structure information of the object.

As can be easily understood from the foregoing, the basic concepts of the present inventive technology may be embodied in a variety of ways. It may involve both data manipulation techniques as well as devices to accomplish the appropriate data manipulation. In this application, the data manipulation techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this patent application is intended to serve as a basic description. The reader should be aware that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. Again, these are implicitly included in this disclosure. Where the invention is described in device-oriented terminology, each element of the device implicitly performs a function. Apparatus claims may not only be included for the device described, but also method or process claims may be included to address the functions the invention and each element performs. Neither the description nor the terminology is intended to limit the scope of the claims that will be included in any subsequent patent application.

It should also be understood that a variety of changes may be made without departing from the essence of the invention. Such changes are also implicitly included in the description. They still fall within the scope of this inventive technology. A broad disclosure encompassing both the explicit embodiment(s) shown, the great variety of implicit alternative embodiments, and the broad methods or processes and the like are encompassed by this disclosure and may be relied upon when drafting the claims for any subsequent patent application. It should be understood that such language changes and broader or more detailed claiming may be accomplished at a later date (such as by any required deadline) or in the event the applicant subsequently seeks a patent filing based on this filing. With this understanding, the reader should be aware that this disclosure is to be understood to support any subsequently filed patent application that may seek examination of as broad a base of claims as deemed within the applicant's right and may be designed to yield a patent covering numerous aspects of the invention both independently and as an overall system.

Further, each of the various elements of the inventive technology and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the inventive technology, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this inventive technology is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “format” should be understood to encompass disclosure of the act of “formatting”—whether explicitly discussed or not—and, conversely, were there effectively disclosure of the act of “formatting”, such a disclosure should be understood to encompass disclosure of a “format” and even a “means for formatting”. Such changes and alternative terms are to be understood to be explicitly included in the description.

Any patents, publications, or other references mentioned in this application for patent are hereby incorporated by reference in their entirety. Any priority case(s) claimed by this application is hereby appended and hereby incorporated by reference in its entirety. In addition, as to each term used it should be understood that unless its utilization in this application is inconsistent with a broadly supporting interpretation, common dictionary definitions should be understood as incorporated for each term and all definitions, alternative terms, and synonyms such as contained in the Random House Webster's Unabridged Dictionary, second edition, as well as “Webster's New World Computer Dictionary”, Tenth Edition and Barron's Business Guides “Dictionary of Computer and Internet Terms”, Ninth Edition are hereby incorporated by reference. Finally, all references listed in the list of References To Be Incorporated By Reference or other information statement filed with the application are hereby appended and hereby incorporated by reference in their entirety, however, as to each of the above, to the extent that such information or statements incorporated by reference might be considered inconsistent with the patenting of this/these inventive technology such statements are expressly not to be considered as made by the applicant(s).

Thus, the applicant(s) should be understood to have support to claim and make a statement of invention to at least: i) each of the data manipulation devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) each system, method, and element shown or described as now applied to any specific field or devices mentioned, x) methods and apparatuses substantially as described hereinbefore and with reference to any of the accompanying examples, xi) the various combinations and permutations of each of the elements disclosed, xii) each potentially dependent claim or concept as a dependency on each and every one of the independent claims or concepts presented, and xiii) all inventions described herein.

In addition and as to computer aspects and each aspect amenable to programming or other electronic automation, the applicant(s) should be understood to have support to claim and make a statement of invention to at least: xvi) processes performed with the aid of or on a computer as described throughout the above discussion, xv) a programmable apparatus as described throughout the above discussion, xvi) a computer readable memory encoded with data to direct a computer comprising means or elements which function as described throughout the above discussion, xvii) a computer configured as herein disclosed and described, xviii) individual or combined subroutines and programs as herein disclosed and described, xix) the related methods disclosed and described, xx) similar, equivalent, and even implicit variations of each of these systems and methods, xxi) those alternative designs which accomplish each of the functions shown as are disclosed and described, xxii) those alternative designs and methods which accomplish each of the functions shown as are implicit to accomplish that which is disclosed and described, xxiii) each feature, component, and step shown as separate and independent inventions, and xxiv) the various combinations and permutations of each of the above.

With regard to claims whether now or later presented for examination, it should be understood that for practical reasons and so as to avoid great expansion of the examination burden, the applicant may at any time present only initial claims or perhaps only initial claims with only initial dependencies. Support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible.

Finally, any claims set forth at any time are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

1-484. (canceled)

485. A method for processing conferenced data comprising the steps of:
creating an electronic identity signature for a known individual having a byte order arrangement;
pre-storing said electronic identity signature for said known individual having a byte order arrangement in an electronic memory;
automatically initiating conferenced electronic communications among a plurality of prospective conference participants;
automatically capturing at least one electronic identity characteristic of each of said plurality of prospective conference participants having a byte order representation;
automatically comparing said byte order representation of said electronic identity characteristic of each of said plurality of prospective conference participants to said byte order arrangement of said electronic identity signature for said known individual;
automatically verifying the identity of each of said plurality of prospective conference participants based on said step of automatically comparing;
terminating communication with any prospective conference participant whose identity is not successfully verified;
exchanging conferenced electronic communications among a plurality of remaining conference participants;
creating a byte order representation of at least one conferenced data element of said exchanged conferenced electronic communications;
associating a conferenced data tag to said conferenced data element of said exchanged conferenced electronic communications having a byte order representation;
creating derivative conferenced data having a byte order arrangement as a result of said step of associating a conferenced data tag to said conferenced data element of said exchanged conferenced electronic communications having a byte order representation.

486. A method for processing conferenced data as described in claim 485 wherein said steps of creating an electronic identity signature and automatically capturing at least one electronic identity characteristic comprise the step of utilizing unique personal data.

487. A method for processing conferenced data as described in claim 485 wherein said step of automatically verifying the identity of each of said plurality of prospective conference participants comprises the step of automatically verifying the identity of each of said plurality of prospective conference participants when a byte order representation of said electronic identity signature for any said prospective conference participant falls within a deviation threshold.

488. A method for processing conferenced data as described in claim 485 further comprising the steps of populating a primary conferenced data structure with primary conferenced data content and populating a secondary conferenced data structure with derivative conferenced data.

489. A method for processing conferenced data as described in claim 488 further comprising the step of relating a byte order arrangement of said primary conferenced data content to a byte order representation of a desired conferenced data element of said derivative conferenced data.

490-494. (canceled)

495. A method for selectively denying access to conferenced electronic communications comprising the steps of:
automatically detecting at least one conference participant to an exchange of conferenced electronic communications;
automatically capturing at least one electronic identity characteristic of said at least one conference participant to said exchange of conferenced electronic communications;
automatically analyzing said at least one captured electronic identity characteristic of said at least one conference participant to said exchange of conferenced electronic communications;
automatically selectively denying access to said at least one conference participant to said exchange of conferenced electronic communications based on said step of automatically analyzing said at least one captured electronic identity characteristic.

496-512. (canceled)

513. A method for completing an exchange of conferenced electronic communications comprising the steps of:
automatically initiating conferenced electronic communications among a plurality of prospective conference participants;
automatically capturing at least one electronic identity characteristic of each of said plurality of prospective conference participants to said initiated exchange of conferenced electronic communications;
automatically analyzing each said captured electronic identity characteristic of each of said plurality of prospective conference participants to said initiated exchange of conferenced electronic communications;
automatically verifying the identity of each of said plurality of prospective conference participants based on said step of automatically analyzing each said captured electronic identity characteristic;
automatically completing said initiated conferenced electronic communications only among said prospective conference participants whose identity has been successfully verified.

514-538. (canceled)

539. A method for creating derivative conferenced data comprising the steps of:
exchanging conferenced electronic communications among a plurality of conference participants;
identifying at least one conferenced data element within said exchange of conferenced electronic communications;
associating a conferenced data tag to said at least one identified conferenced data element within said exchange of conferenced electronic communications;
creating derivative conferenced data as a result of said step of associating a conferenced data tag to said at least one identified conferenced data element within said exchange of conference electronic communications.

540. A method for creating derivative conferenced data as described in claim 539 further comprising the step of deriving an augmented functionality for said conferenced data element from said conferenced data tag associated to said at least one identified conferenced data element.

541. A method for creating derivative conferenced data as described in claim 539 wherein said steps of identifying at least one conferenced data element and associating a conferenced data tag comprise the steps of manually identifying at least one conferenced data element and manually associating a conferenced data tag.

542. A method for creating derivative conferenced data as described in claim 541 wherein said step of manually identifying at least one conferenced data element comprises the step of manually identifying selected from the group consisting of manually identifying by time, manually identifying by date, manually identifying by name, manually identifying by conference participant, manually identifying by agenda item, manually identifying by conference exhibit, manually identifying by file type, and manually identifying by electronic identity characteristic.

543. A method for creating derivative conferenced data as described in claim 541 wherein said step of manually identifying at least one conferenced data element comprises the step of manually identifying changed conferenced data.

544. A method for creating derivative conferenced data as described in claim 543 wherein said step of manually identifying changed conferenced data comprises the step of manually identifying changed participant information, changed agenda information, and changed exhibit information.

545. A method for creating derivative conferenced data as described in claim 541 wherein said step of manually associating a conferenced data tag comprises the step of associating a conferenced data tag selected from the group consisting of associating by manual data entry, associating by voice, and associating by silent tagging.

546. A method for creating derivative conferenced data as described in claim 539 wherein said steps of identifying at least one conferenced data element and associating a conferenced data tag comprise the steps of automatically identifying at least one conferenced data element and automatically associating a conferenced data tag.

547. A method for creating derivative conferenced data as described in claim 546 wherein said step of automatically identifying at least one conferenced data element comprises the step of automatically identifying selected from the group consisting of automatically identifying by time, automatically identifying by date, automatically identifying by name, automatically identifying by conference participant, automatically identifying by agenda item, automatically identifying by conference exhibit, automatically identifying by file type, and automatically identifying by electronic identity characteristic.

548. A method for creating derivative conferenced data as described in claim 546 wherein said step of automatically identifying at least one conferenced data element comprises the step of automatically identifying changed conferenced data.

549. A method for creating derivative conferenced data as described in claim 548 wherein said step of automatically identifying changed conferenced data comprises a step selected from the group consisting of automatically identifying changed participant information, automatically identifying changed agenda information, and automatically identifying changed exhibit information.

550. A method for creating derivative conferenced data as described in claim 546 wherein said step of automatically associating a conferenced data tag comprises the step of associating a conferenced data tag selected from the group consisting of associating in real time, associating in near real time, and associating in post processing.

551. A method for creating derivative conferenced data as described in claim 539 further comprising the steps of:
establishing a primary conferenced data structure;
populating said primary conferenced data structure with primary conferenced data content;
arranging said primary conferenced data content of said primary conferenced data structure in a byte order.

552. A method for creating derivative conferenced data as described in claim 551 wherein said conferenced data comprises conferenced data selected from the group consisting of speech data, verbal data, voice data, phoneme data, text data, image data, visual data, audio data, video data, analog data, digital data, object code data, source code data, telephony data, ANI data, metadata, time data, date data, agenda data, exhibit data, conference participant data, topic data, word data, sentence data, caption data, file type data, contextual indicia data, and any combination thereof.

553. A method for creating derivative conferenced data as described in claim 552 wherein said steps of identifying at least one conferenced data element within said exchange of conferenced electronic communications and associating a conferenced data tag to said at least one identified conferenced data element within said exchange of conference electronic communications comprise the step of creating a byte order representation of a desired conferenced data element.

554. A method for creating derivative conferenced data as described in claim 553 wherein said step of creating derivative conferenced data comprises the step of relating said byte order representation of said desired conferenced data element to said byte order arrangement primary conferenced data content.

555. A method for creating derivative conferenced data as described in claim 554 wherein said step of relating comprises the step of comparing said byte order representation of said desired conferenced data element to said byte order arrangement of said primary conferenced data content.

556. A method for creating derivative conferenced data as described in claim 554 wherein said step of relating comprises the steps of:
establishing a secondary conferenced data structure;
populating said secondary conferenced data structure with said derivative conferenced data.

557. A method for creating derivative conferenced data as described in claim 556 further comprising the steps of:
storing said primary conferenced data structure and said secondary conferenced data structure;
accessing said desired conferenced data element within said primary conferenced data structure utilizing said derivative conferenced data of said secondary conferenced data structure.

558. A method for creating derivative conferenced data as described in claim 557 wherein said step of storing said primary conferenced data structure and said secondary conferenced data structure comprises the step of creating a database of primary conferenced data and secondary conferenced data.

559. A method for creating derivative conferenced data as described in claim 557 wherein said step of accessing said desired conferenced data element comprises a step selected from the group consisting of retrieving said desired conferenced data element, retrieving said desired conferenced data element in situ, retrieving said desired conferenced data element separate from surrounding content, sorting said desired conferenced data element, delivering said desired conferenced data element to a communications device, and delivering said desired conferenced data element to a media output device.

560. A method for creating derivative conferenced data as described in claim 554 wherein said step of relating comprises a step selected from the group consisting of data mining said primary conferenced data, post processing said primary conferenced data, and post process data mining said primary conferenced data.

561-581. (canceled)

582. A method for electronic identity verification comprising the steps of:
creating an electronic identity signature for a known individual;
pre-storing said electronic identity signature for said known individual;
automatically capturing at least one electronic identity characteristic of an unknown individual;
automatically analyzing said at least one captured electronic identity characteristic of said unknown individual in relation to said pre-stored electronic identity signature for said known individual;
automatically verifying the identity of said unknown individual based on said step of automatically analyzing said captured electronic identity characteristic.

583-601. (canceled)
